(19) United States
(12) Patent Application Publication
(10) Pub. No.: US 2026/0296897 A1
(43) Pub. Date: Oct. 1, 2026

(54) METHODS FOR THE SYNTHESIS AND ALKYL-FUNCTIONALIZATION OF MXENES

(71) Applicant: The University of Chicago, Chicago, IL (US)

(72) Inventors: Dmitri V. Talapin, La Grange Park, IL (US); Di Wang, Chicago, IL (US); Noah Mason, Chicago, IL (US)

(21) Appl. No.: 19/570,984

(22) Filed: Mar. 18, 2026

Related U.S. Application Data
(60) Provisional application No. 63/777,897, filed on Mar. 26, 2025.

(51) Int. Cl. C01B 32/921

(52) U.S. Cl. CPC C01B 32/921; C01P 2002/08; C01P 2002/72; C01P 2002/85; C01P 2002/86; C01P 2004/03; C01P 2004/04

(57) ABSTRACT

Methods for the direct synthesis of carbide MXenes by reacting a transition metal with an alkyl halide compound are provided. The MXenes are useful in a wide range of applications and devices, including supercapacitors, batteries, and as electromagnetic interference (EMI) shielding. The direct synthesis methods can produce a variety of carbide MXenes with high purities, including MXenes that have not previously been synthesized, such as MXenes having mixed halide surface functionalization. Also provided are methods for the covalent surface substitution of MXenes with alkyl groups. These alkylated MXenes have applications in catalysis, including for the catalysis of acetylene and ethylene deletion and C—N coupling.

### CROSS-REFERENCE TO RELATED APPLICATION

The present application claims priority to U.S. Provisional Patent Application No. 63/777,897 filed on Mar. 26, 2025, the entire disclosure of which is incorporated herein by reference.

### REFERENCE TO GOVERNMENT RIGHTS

This invention was made with government support under FA9550-22-1-0283 awarded by the Air Force Office of Scientific Research, and 2318105 awarded by the National Science Foundation. The government has certain rights in the invention.

### BACKGROUND

Two-dimensional (2D) materials show unique properties that have led to their extensive study for diverse applications. 2D materials are mainly dielectrics, semiconductors, or semimetals. MXenes are an emerging family of 2D transition metal carbides and nitrides, most of which are metallic conductors. (B. Anasori et al., Nature Reviews Materials 2, 16098 (2017).) Thus, they are actively studied for their promising performance in energy storage, electromagnetic interference (EMI) shielding, and catalysis.

MXenes are represented by the general formula of Mₙ₊₁XₙTₓ (n=1-4), where M represents one or more early transition metals, X is carbon (C) or nitrogen (N), and Tₓ surface-terminating atoms or chemical groups. The MXene structure is characterized by n+1 hexagonally packed M layers interleaved with n layers of X atoms. The M layers are capped by the surface termination groups. Examples of MXenes include Ti₂CCl₂ and Ti₃C2Cl₂.

The direct synthesis of Ti₂CCl₂ MXene through a reaction between titanium (Ti) metal, graphite and TiCl₄ has been reported. (Wang, D. et al., Science 2023, 379 (6638), 1242-1247.) The method bypasses etching of a precursor phase and produces stacked MXene layers with complete and uniform coverage of surface halides. However, the formation of titanium carbide, TiCₓ, by-products in sizable amounts was reported. At lower reaction temperatures, the formation of MXene phases was more favorable than the formation of TiCₓ, but graphite is less reactive and remained as a by-product. Improvements in the efficiency of the direct synthesis of MXenes have been realized by reacting TiCl₃ with CH₄ in a fluidized bed reactor. (Xiang, M. Q. et al., Innovation 2024, 5 (1).) However, the corrosive nature of titanium chlorides poses a significant problem for widespread adoption of MXenes synthesized by this method. (Kapias, T. et al., Journal of Hazardous Materials 2005, 119 (1-3), 41-52.) Thus, alternative synthesis schemes are needed to improve the purity of MXenes and to expand the choice of precursors available for MXene synthesis to accelerate the accessibility, growth, and production of MXene family members.

Chemical intercalation and functionalization of low-dimensional materials, including MXenes, can lead to profound changes in their properties and can stabilize them in organic solvents. Covalent attachment or replacement of functional groups typically has been carried out at elevated temperature in pressurized vessels or molten salts. For example, Lewis acidic molten salt (LAMS) etching has been used to form halogen terminated MXenes. (Kamysbayev, Vladislav, et al. Science 369.6506 (2020): 979-983; and Li, Youbing, et al. Nature Materials 19.8 (2020): 894-899.) Among these, MXenes with uniform halogen termination are gaining interest because their uniform surface termination enables precise surface engineering. It has been demonstrated that multiple MXenes with uniform halogen terminations can be obtained through direct synthetic routes. However, uniform surface termination without oxygen makes intercalation and delamination of MXenes very difficult. Therefore, additional methods for synthesizing and functionalizing MXenes are needed.

### SUMMARY

Two-dimensional transition metal carbide MXenes, alkylated two-dimensional transition metal MXenes, methods for synthesizing the two-dimensional transition metal carbide MXenes and the alkylated two-dimensional transition metal MXenes, and methods for using the alkylated two-dimensional transition metal MXenes to catalyze a deacetylenative or deethylenative C—N coupling of an alkene or alkyne molecule are provided.

One embodiment of a two-dimensional transition metal carbide MXene has a formula Mₙ₊₁Cₙ (T′_{y}T″_{1-y})ₓ, where 1≤n≤4, M represents one or more early transition metals, T′ and T″ represent two different halogen atoms, and 0<y<1. An example of these two-dimensional transition metal carbide MXenes include Ti₂C(Cl_{y}Br_{1-y})₂, where 0<y<1 and Nb₂C(Cl_{y}Br_{1-y})₂.

One embodiment of an alkylated two-dimensional transition metal MXene has a formula Mₙ₊₁XₙTₓ, where 1≤n≤4, M one or more transition metals, X is carbon or nitrogen, and Tₓ are surface terminating atoms or groups, wherein at least some of the surface terminating atoms or groups are alkyl groups covalently bonded in M atoms of the MXene via C-M bonds.

One embodiment of a method for the synthesis of a two-dimensional transition metal carbide MXene having a formula Mₙ₊₁CₙTₓ, where 1≤n≤4, M is an early transition metal, and Tₓ are surface terminating halogen atoms includes the step of: reacting the early transition metal with one or more alkyl halide compounds at a temperature at which the reaction forms the two-dimensional transition metal carbide MXene.

One embodiment of a method of alkylating a two-dimensional transition metal MXene having a formula Mₙ₊₁XₙTₓ, where 1≤n≤4, M is an early transition metal, X is carbon or nitrogen, and Tₓ are surface terminating halogen atoms, the two-dimensional transition metal carbide MXene comprising a stack of monolayer MXene sheets, includes the steps of: electrochemically reducing the two-dimensional transition metal carbide MXene having the formula Mₙ₊₁XₙTₓ in an electrolyte solution comprising an alkyl group-functionalized quaternary organic cation in a polar aprotic solvent, wherein the electrochemical reduction drives intercalation of the alkyl group-functionalized quaternary organic cation between the monolayer MXene sheets and the formation of an ionic quaternary organic cation-MXene compound; and replacing the polar aprotic solvent with a non-polar solvent to induce a carbocation transfer between alkyl groups on the alkyl group-functionalized organic cation and early transition metal atoms of the two-dimensional transition metal carbide MXene to form the alkylated two-dimensional transition metal carbide MXene.

One embodiment of a method of catalyzing a deacetylenative or deethylenative C—N coupling of an alkene or alkyne molecule includes the step of reacting the alkene or alkyne molecule with ammonia, a primary amine, or a secondary amine in the presence of the alkylated two-dimensional transition metal MXene of a type described herein under conditions that promote the C—N coupling of the alkene or alkyne molecule.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1, panels (a)-(c): Electrochemical surface engineering of M₂CCl₂ MXenes. A schematic diagram of a mechanism involving a polarity inversion at MXene surfaces is shown.

FIG. 2: Deacetylenative C—N coupling catalysis using an Nb₂CCl_{0.8}Oct_{0.2} MXenes. The reaction, examples of substrates, and a proposed mechanism are shown.

FIGS. 3A-3G: CH₂Cl₂ and CH₂Br₂ serve as efficient precursors for MXene synthesis. FIG. 3A shows X-ray diffraction (XRD) patterns of MXenes synthesized from CH₂Cl₂ or CH₂Br₂. The arrows show the trend of in-plane diffraction peaks shifting to lower angles proceeding from Ti₂C to Nb₂C to Zr₂C. FIGS. 3B-3G show a collection of SEM images of the products shown in (FIG. 3B) Ti₂CCl₂, (FIG. 3C) Ti₂CBr₂, (FIG. 3D) Nb₂CCl₂, (FIG. 3E) Nb₂CBr₂, (FIG. 3F) Zr₂CCl₂, (FIG. 3G) Zr₂CBr₂.

FIG. 4 shows XRD patterns of Ti₂CCl₂ products after reacting different Ti starting materials with CH₂Cl₂ at 830° C. in a CVD synthesis.

FIGS. 5A-5E show SEM images of final Ti₂CCl₂ MXenes after reacting with CH₂Cl₂ at 830° C. from a Ti powder (FIG. 5A), Ti sponge (FIG. 5B), Ti foil (FIG. 5C), Ti felt (FIG. 5D), and Ti mesh (FIG. 5E).

FIG. 6A shows a scanning transmission electron microscopy (STEM) image of Ti₂CBr₂ flakes. FIG. 6B shows high resolution STEM imaging showing layered atomic columns in a Ti₂CBr₂ particle. Br has a higher atomic number and interaction section with the electron beam than Ti and appears brighter in a dark field image.

FIG. 7A shows an XRD pattern of products from reacting Nb with a mixture of CH₂Cl₂ and CH₂Br₂ (1:1 molar ratio) at 800° C. (denoted as DS-Nb₂CClBr), in comparison to XRD patterns of DS-Nb₂CCl₂ and DS-Nb₂CBr₂ MXenes. FIG. 7B shows a zoomed in view of in-plane (1010) diffraction peaks showing the trend of increasing in-plane lattice parameters from DS-Nb₂CCl₂ to DS-Nb₂CClBr to DS-Nb₂CBr₂ due to the increasing surface group sizes. FIG. 7C shows an energy dispersive x-ray spectroscopy (EDX) spectrum showing an elemental ratio of Nb:Cl:Br=2:1.1:1.2 in DS-Nb₂CClBr, which is close to the expected 2:1:1 ratio. FIG. 7D shows an SEM image of DS-Nb₂CClBr. FIG. 7E shows the corresponding EDX maps indicating an overall homogeneous distribution of Nb, Cl, Br and carbon. The above evidence demonstrates the successful preparation of Nb₂C MXene with mixed (Cl and Br) terminal groups through a direct synthetic route.

FIGS. 8A-8F: Assessment of the thermodynamic accessibility of MXenes through the enthalpy of MXene direct synthesis and competing reactions calculated by density function theory (DFT). FIG. 8A shows MXenes form when the reactions forming MXene phases are more exothermic than the most competitive side reactions, ΔH*=ΔH_{MXene}−ΔH_{By}<0. FIG. 8B shows cubic transition metal carbide by-products are thermodynamically more favorable when ΔH*=ΔH_{MXene}−ΔH_{By}>0. Assessment of the feasibility of M₂CX₂ (M=Ti, Zr, Nb; X═Cl, Br) MXenes by plotting the ΔH* of reactions involving M=(FIG. 8C) Ti, (FIG. 8D) Zr, and (FIG. 8E) Nb and a series of organohalide precursors CH₂Cl₂ (DCM), CHCl₃, C₂Cl₄, C₂Cl₆, CCl₄, CH₂Br₂ (DBM), CBr₄. FIG. 8F shows a theoretical comparison of ΔH* targeting Ti₃C₂Cl₂ and Ti₂CCl₂ MXenes. All ΔH values have been normalized by the number of M participating reactions.

FIGS. 9A-9B: Gram-scale synthesis of M₂CCl₂ MXenes using reduced organohalides in a chemical vapor deposition (CVD) furnace. FIG. 9A shows an XRD pattern of Ti₂CCl₂ synthesized from a titanium sponge FIG. 9B shows an SEM image of the gram-scale Ti₂CCl₂ product.

FIG. 10: EDX spectrum of a DS-Ti₂CCl₂ sample for sample purity calculation.

FIG. 11A shows an SEM image of Ti₂CCl₂ MXenes made from Ti-6Al-4V turnings. FIG. 11B shows an EDX map with 1 at. % V composition after reacting. This demonstrates early transition metal alloys used can retain mixed metal compositions in the MXenes after reacting to yield mixed metal MXenes.

FIG. 12 shows XRD patterns and elemental ratios of Nb₂CCl₂-TBAC before and after an electrolysis.

FIGS. 13A-13C: Structural characterization of electrochemically engineered M₂C MXenes. FIG. 13A shows XRD patterns and corresponding structure illustrations of an M₂CCl₂ MXene before and after and electrochemical treatment. The out-of-plane diffraction peaks and interlayer spacings are given. FIG. 13B and FIG. 13C are scanning electron microscopy-energy dispersive X-ray spectroscopy (SEM-EDX) and X-ray photoelectron spectroscopy (XPS) N is spectra of different stages of a M₂C MXene showing the morphology and composition differences.

FIG. 14 shows powder XRD patterns of alkyl functionalized Nb₂C MXenes.

FIGS. 15A-15D: Investigation of organometallic bonding in Nb₂CCl_{0.8}Bu_{0.2} MXene using solid-state nuclear magnetic resonance (ssNMR). FIG. 15A shows a 1H-¹³C idHETCOR spectrum of Nb₂CCl_{0.8}Bu_{0.2} MXene, showing the carbon signals are correlated with proton signals, indicating alkyl groups. The width of signal also suggests anisotropy of bound organic fragments. FIG. 15B shows signal and FIG. 15C shows curve fitting of ¹H{⁹³N} DE-RESPDOR experiments. FIG. 15D shows direct excitation NMR spectra of 93Nb under different magnetic fields.

FIG. 16 shows a ¹H NMR spectrum of C—N coupling product from aniline and 1-octyne.

FIG. 17 shows a ¹³C NMR spectrum of C—N coupling product from aniline and 1-octyne.

### DETAILED DESCRIPTION

Methods for the direct synthesis of carbide MXenes by reacting a transition metal with an alkyl halide compound are provided. The MXenes are useful in a wide range of applications and devices, including supercapacitors, batteries, and as electromagnetic interference (EMI) shielding. The direct synthesis methods can produce a variety of carbide MXenes with high purities, including MXenes that have not previously been synthesized, such as MXenes having mixed halide surface functionalization. The direct synthesis methods can be scaled up efficiently and can use a variety of different transition metal starting materials, including starting materials that include more than one type of transition metal. Also provided are methods for the covalent surface substitution of MXenes with alkyl groups. These alkylated MXenes have applications in catalysis, including for the catalysis of deacetylenative or deethylenative C—N coupling.

### Direct Synthesis of MXenes.

The carbide MXenes are 2D transition metal carbides having the formula Mₙ₊₁CₙTₓ, where 1<n<4; M represents one or more types of early transition metal elements, and Tₓ are surface terminating atoms or chemical groups. While Tₓ is generically used to represent surface terminating atoms or groups, the number of which may vary; in some embodiments x is ≤2. The MXene structure can be described as n+1 hexagonally packed M layers interleaved with n layers of C atoms. The M layers are then capped by the surface terminating groups. In the as-synthesized MXenes, Tₓ represents halogen atoms, such as bromine (Br), chloride (Cl), fluorine (F), iodine (I), or a combination of two or more thereof. However, post-synthesis, these halogen atoms can be eliminated or replaced by other surface terminating atoms or groups using, for example, nucleophilic substitution.

The MXenes include those having only single type of early transition metal element, M, and mixed metal MXenes comprising two or more types of early transition metal elements. In a mixed metal MXene (e.g., (Ti, V)₂CCl₂), the Mₙ₊₁CₙTₓ formula is interpreted as follows:

$${( {M}_{{a}_{1}}^{1} {M}_{{a}_{2}}^{2} … {M}_{{a}_{k}}^{k} )}_{n + 1} {C}_{n} {T}_{x} ,$$

wherein 1≤n≤4; k≥3; each Mⁱ is a different early transition metal either ordered or arranged as a solid solution; aᵢ>0 and Σaᵢ=1, and Tₓ are surface terminating atoms or chemical groups. Mixed metal MXenes can be formed using mixed metal starting materials, as illustrated in Example 2.

The early transition metals are 3d-5d block transition metals (Groups 3-7 of the periodic table), including scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), and manganese (Mn). Any two or more of these elements can be combined in a mixed metal MXene. In some embodiments, one of the two or more early transition metal elements includes Ti or Nb.

The transition metal reactants are generally solid reactants and may be provided, for example, in the form of a metal, including metal alloy, powder, sponge, turning, foil, felt, or mesh on which the reaction occurs. The alkyl halide compound reactants can be represented by the general formula CH_{4-z}X_{z}, where X is the halogen atom that will become a surface terminating atom in the MXene and z is 1, 2 or 3. If a high-purity MXene product is required or desired, it is generally preferable to use lower-valence alkyl halides, such as CH₂Cl₂, CHCl₃, CH₂I₂, or CH₂Br₂, in the reaction. The reaction mixture can include a single type of alkyl halide or a mixture of two or more different alkyl halides, wherein the different alkyl halides contain different halogen atoms.

Without intending to be bound to any particular theories of the inventions disclosed herein, the ability to produce phase-pure or substantially phase-pure MXenes can be explained by the enthalpies of the reactions forming the MXene products, relative to the enthalpies of the reactions forming competing side reactions that produce non-MXene by-products, such as cubic transition metal carbide phases, other carbides, or oxide and/or oxyhalide by-products; based on enthalpy, the synthesis of MXenes is energetically more favorable for the lower valence alkyl halides than for higher valence reactants. By way of illustration, when Ti metal is reacted with the high-valence reactant CBr₄, non-MXene phase products are favored to the exclusion of the Ti₂CBr₂ MXene. However, replacing CBr₄ with a lower valence alkyl halide, such as CH₂Br₂, results in the successful synthesis of Ti₂CBr₂.

By way of illustration, MXenes can be synthesized with a purity of 85% or higher, 90% or higher, 95% or higher, 98% or higher, 99% or higher, and 99.9% or higher using the methods described herein. The purity of the MXenes can be measured via X-ray diffraction (XRD) full-pattern fitting (Reitveld refinement) and elemental analysis, as illustrated in Example 1.

The high-purity MXenes can provide benefits over their lower purity counterparts for various applications. For example, high-purity MXenes, including high-purity M₂CT₂ MXenes (e.g., Ti₂CCl₂) having higher gravimetric capacitance relative to their less pure counterparts and can provide improved performance in supercapacitor and energy storage applications. Additionally, higher-purity MXenes can be better catalysts in hydrogen evolution reactions relative to less-pure MXenes.

Another notable benefit of the absence or near-absence of non-MXene by-products is that the alkyl halide reactants can produce MXenes with mixed halide surface terminations by using two different alkyl halide reactants. Such “mixed halide” MXenes have at least two different surface terminating halide atoms. MXenes having surface terminating groups that consist of only two different halides are represented by the formula Mₙ+1Cₙ(T′_{y}T″_{1-y})ₓ, where M, n, and Tₓ are as previously defined, but T′ and T″ represent two different types of halide atoms, and 0<y<1. In some embodiments of the MXenes with mixed halide termination, T′ and T″ represent a combination of two or more of Cl, I, and Br atoms. Such MXenes can be formed using, for example, a reaction mixture containing a mixture of CH₂Cl₂, CH₂12, and CH₂Br₂, including reaction mixtures of CH₂Cl₂ and CH₂Br₂. The ability to produce MXenes, including mixed metal MXenes, with mixed halide termination can be attributed to the fact that halogen atoms do not get consumed by non-MXene by-product phases, such as oxyhalides, during the synthesis. Because the formation of halogen-containing non-MXene phases can preferentially remove one halide in a reaction system containing two or more different halides, the formation of non-MXene by-product phases can make the synthesis of MXenes with mixed halide terminations challenging and may even prevent the formation of MXenes with mixed halide terminations altogether. The ability to produce MXenes with mixed halogen terminations is advantageous because it expands the scope of possible post-synthetic modifications and enables precise control over the electronic structure of the MXenes. This can result in improved and/or tunable properties such as conductivity, work function, and catalytical performance.

MXene synthesis from reduced organohalides (e.g., reduced forms of CCl₄, CI₄, or CBr₄) is also advantageous as it enables the use of relatively inexpensive, less pure early transition metal starting materials, such as metal sponges and metal alloys, to yield high purity single metal MXenes and mixed metal MXenes from cost-effective starting materials. The ability to form mixed metal MXenes is advantageous because it allows greater flexibility in synthesizing MXenes with a broad range of physical and chemical properties and surface reactivities.

The direct reaction of the early transition metals and alkyl halide compounds can be carried out by combining the reactants in a reaction vessel where they react to form the MXene. The reactants can be heated to thermally induce the reaction, increase the reaction rate, and/or increase the yield of the MXene phase over other phases that are formed as products of the reaction. Because the alkyl halides are highly reactive, the reactions can be carried out at relatively low reaction temperatures (e.g., 1000° C. or lower), which facilitates the synthesis of high purity MXene products. The optimal reaction temperature will depend on the reactant being used. Generally, however, temperatures in the range from about 650° C. to 1000° C., including from 700° C. to 900° C., are suitable. In the synthesis of MXenes with mixed halide surface termination, the ratio of T′ to T″ groups in the product MXenes can be adjusted by altering the molar ratio of T′-containing and T″-containing alkyl halides in the reaction mixture and/or by adjusting the reaction temperature. By way of illustration only, T′ to T″ ratios in the range from 1:10 to 10:1, including in the range from 1:5 to 5:1 can be achieved. Typically, a higher temperature favors smaller halide (e.g., chloride) incorporation over larger halide (e.g., bromide) incorporation.

Carrying out the direct synthesis of the MXenes with a hydrogenated transition metal starting material is advantageous, as it can improve the yield of the MXene phase. The transition metal starting material (e.g., powder or bulk metal substrate) can be hydrogenated by, for example, carrying out the reaction in a hydrogen-containing environment, reacting a transition metal starting product with LiH, or purchasing a pre-hydrided metal. The hydrogenation of the transition metal reactant can improve the yield of the MXene phase by, for example, suppressing the formation of by-products, such as transition metal oxyhalides. This effect is less important when utilizing reduced alkyl halides as they can create a more reducing environment when heated to reaction temperatures.

The MXenes are formed as stacks of monolayer MXene sheets, and these stacks can be delaminated to obtain individual monolayer MXene sheets. Methods for delaminating stacks of MXene sheets are known. The monolayer MXene sheets have excellent pseudocapacitive energy storage properties originating from efficient ion intercalation between the 2D monolayers. Their excellent electrochemical energy storage characteristics stem from the combination of large surface-to-volume ratio and high electrical conductivity.

An alternative method for the direct synthesis of the carbide MXenes is direct synthesis via chemical vapor deposition (CVD). CVD growth is a bottom-up growth process in which the MXenes are formed epitaxially on the surface of an early transition metal growth substrate by the thermal decomposition of the alkyl halide compounds. CVD growth generally proceeds through a series of stages. First, the vapor-phase alkyl halides diffuse to the early transition metal surface of the substrate where they are adsorbed. Reactions between the transition metal of the surface and the vapor-phase reactants grow the MXenes from the surface, and gaseous by-products of the reactions are separated from the surface. In preparation for CVD growth, the growth substrate is loaded into a CVD reactor chamber and heated to a temperature at which the MXene growth will be carried out—typically a temperature in the range from 650° C. to 1000° C. The alkyl halide reactants are introduced into the CVD reactor chamber as a vapor comprising the reactants and, typically, an inert gas carrier. The reactants are transported to the substrate surface via fluid transport and/or diffusion where they undergo decomposition and heterogeneous reactions with the transition metal growth surface to form the MXenes. In the CVD synthesis of MXenes with mixed halide surface termination, the ratio of T′ to T″ groups in the product MXenes can be adjusted by altering the molar ratio of T′-containing and T″-containing alkyl halides in the reaction mixture and/or by adjusting the reaction temperature.

Because the reactions on the substrate surface may be thermally driven or controlled, the CVD reactor is equipped with a heater, or other energy source, in thermal communication with the substrate to heat the substrate to a temperature that promotes the reactions. The CVD reactor will also include a vacuum pump in fluid communication with the reactor chamber to remove the by-product gasses and maintain the chamber pressure at a desired sub-atmospheric pressure during film growth.

The CVD growth of the MXenes can be used to form a plurality of sheets of MXenes that are bound to the growth substrate along a sheet edge, referred to herein as “carpets.” Alignment of the surface-bound MXene sheets in the carpets allows for efficient ion intercalation and fast charging and discharging cycles for battery electrodes made from the CVD-grown MXenes.

A notable benefit of CVD growth is the ability to easily scale reaction mass compared to direct synthesis using sealed ampoules. This enables MXene synthesis limited only by the size of the CVD tube furnace rather than reagent pressure in a sealed reactor in direct synthesis. In addition, the flow of alkyl halide can be controlled with a mass flow controller (MFC) to increase or decrease the growth of MXenes. This allows for early transition metal substrates to have MXene carpets grown directly on their surface while maintaining the overall physical properties of the substrate. Alternatively, flow or reaction time could be increased to complete the conversion of early-transition metal substrate or reagent into pure MXene powders.

### Covalent Surface Substitution of MXenes to Form Alkylated MXenes

The surface terminating halogen atoms of the carbide MXenes synthesized using the methods described above can be fully or partially substituted with a variety different surface groups using known chemistries. For example, surface terminating halogens can be substituted with amido- or imido-groups using the methods described in Zhou, Chenkun, et al. “Hybrid organic-inorganic two-dimensional metal carbide MXenes with amido- and imido-terminated surfaces.” Nature Chemistry 15.12 (2023): 1722-172.

Alternatively, the surface terminating halogen atoms of the carbide MXenes and other MXenes, including nitride MXenes, can be fully or partially substituted with alkyl groups using an electrochemical intercalation-based polarity inversion and covalent surface functionalization reaction. These reactions, which form X-M bonds between carbon or nitrogen atoms of an intercalated alkyl-functionalized quaternary organic cation and the metal atoms (M) of a MXene, can be used to covalently graft a variety of alkyl groups directly to the MXene.

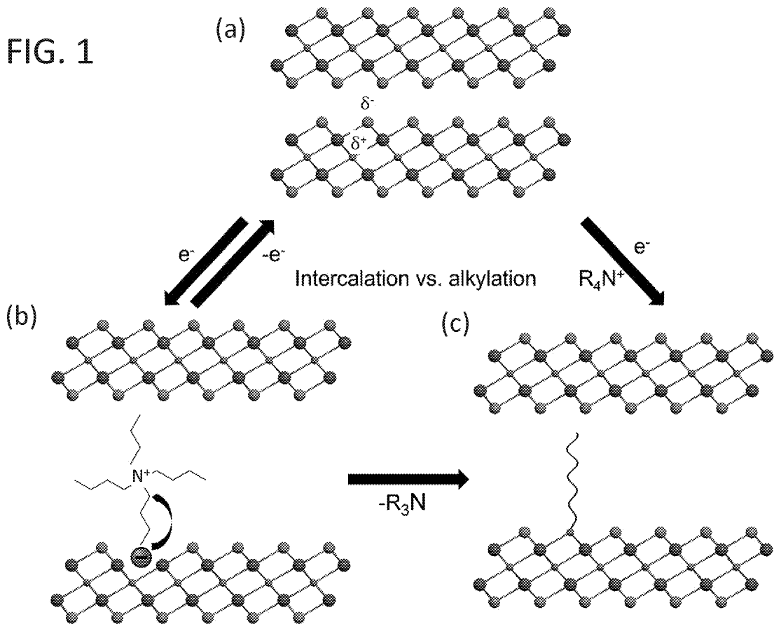

The electrochemical alkyl grafting process is shown schematically in FIG. 1, panels (a)-(c). Initially, the MXene is characterized by an M-T bond polarity in which the metal atom has a partial positive charge and the surface halogen has a partial negative charge (FIG. 1, panel (a)). The partial positive charge on the metal atoms renders those atoms unreactive toward alkyl groups. In the electrochemical grafting methods, the MXene is electrochemically reduced in an electrolyte comprising an alkyl group-functionalized quaternary organic cation. As the result of the electrochemical reduction, the quaternary organic cations become intercalated between monolayer MXene sheets in the stacked MXene structure, the cathodic current inverts the polarity of the metal of the MXene from positive to negative, converting the electrophilic metal atoms to nucleophiles, and surface terminating halogens are eliminated from the MXene. The result is the formation of a quaternary organic cation-MXene ionic compound (FIG. 1, panel (b)). The electrolyte solution is then replaced with a non-polar solvent to promote a nucleophilic substitution reaction between the nucleophilic metal atoms of the MXene and an alkyl group on an alkyl group-functionalized quaternary organic cation, resulting in the elimination of the remainder of the now-neutralized organic cation and the covalent grafting of the alkyl group to the MXene via a carbocation transfer reaction (FIG. 1, panel (c)). The alkylation of the MXenes can be carried out until all surface terminating halogens or replaced by alkyl groups or until only a portion (for example, at least 50%, at least 60%, at least 80%, or at least 90%) of the halogens are substituted by the alkyl groups. As shown in the figure, intercalated MXenes are intermediates of alkylated MXenes. It is possible to stop the reaction at the intermediate intercalation step, isolate the intercalated MXenes, and then trigger the alkylation reaction. However, alkylation can be done as a direct one-pot reaction.

MXenes synthesized via direct synthesis can be used as the starting material for alkylation via electrochemical intercalation-based polarity inversion and covalent surface functionalization. However, MXenes made using other methods, including MXenes made by top-down and bottom-up methods, can also undergo alkylation via electrochemical intercalation-based polarity inversion and covalent surface functionalization. Thus, the methods can be applied to both carbide and nitride MXenes of the general formula Mₙ₊₁XₙTₓ, where 1<n<4, where M and Tₓ are as defined previously herein and X is a carbon or nitrogen atom. Other methods that can be used to form the starting MXene include, but are not limited to, those described in PCT application publication number WO 2024/044510, and MXenes made from MAX phases through selective etching of the A layers.

The alkyl group-functionalized quaternary organic cations that act as carbocation transfer agents are bulky quaternary organic cations, such as quaternary ammonium cations and quaternary phosphonium cations. The quaternary ammonium cations have the formula R₄N⁺ and the quaternary phosphonium cations have the formula R₄P⁺, where R represents alkyl groups, which may be the same alkyl group or different alkyl groups. Suitable alkyl groups include C₂ to C₁₂ and C₄ to C₁₈ alkyl groups, such as butyl groups, hexyl groups, dodecyl groups, and octadecyl groups. Longer alkyl groups can be used provided their quaternary organic salts are sufficiently soluble in a polar p solvent. Illustrative examples of quaternary ammonium cations include tetrabutylammonium cations (TBA⁺), and tetraoctylammonium cations (TOA⁺). Additional illustrative examples include: C₄-C₈ symmetric ammoniums, such as tetrapentylammonium, tetrahexylammonium, and tetraheptylammonium; and symmetric C₄-C₈ phosphoniums, such as tetrabutylphosphonium, tetrapentylphosphonium, tetrahexylphosphonium, tetraheptylphosphonium and tetraoctylphosphonium; and asymmetric ammoniums, such as cetyl(tributyl)ammonium, and didecyl(dioctyl)ammonium. Still other examples include ionic liquid phosphonium cations, such as trihexyl(tetradecyl)phosphonium, trihexyl(decyl)phosphonium, and trihexyl(octyl)phosphonium.

The electrochemical reduction of the metal atoms in the MXenes is carried out in an electrolyte comprising the alkyl group-functionalized organic cations in a polar aprotic solvent. The quaternary organic cations are generally provided as salts, such as halide salts, and dissolved in the electrolyte solvent. Suitable solvents for the electrolyte solution include, but are not limited to, acetonitrile, propylene carbonate, dimethylformamide (DMF), N-methylpyrrolidone (NMP), dimethyl carbonate, diethyl carbonate, ethyl acetate, and mixtures of two or more thereof.

The electrochemical cell can be a two-electrode or three-electrode cell in which the MXene is used as a cathode in electronic communication with a counter electrode. Suitable electrode materials for the counter electrode and, if present, the reference electrode, include graphite and Ag/Ag⁺. However, other electrode materials can be used. When an electrochemical potential is applied, the organic quaternary cations are driven between the monolayer MXene sheets of the stacked, multilayered MXenes, and the electrophilic M atoms are converted into nucleophiles to produce an ionic intercalation compound. Cyclic voltammetry can be used to identify a suitable potential window for the electrochemical cells.

After the electrochemical intercalation, the polarity of the environment is changed from polar to non-polar by replacing the electrolyte solution with a non-polar solvent to induce the carbocation transfer of the alkyl chains on the alkyl-functionalized quaternary organic cations to the metal atoms of the MXene, resulting in the covalent functionalization of the MXene with alkyl groups. Suitable non-polar organic solvents include, but are not limited to, toluene, and hydrocarbons, such as pentane, hexane, and cyclohexane.

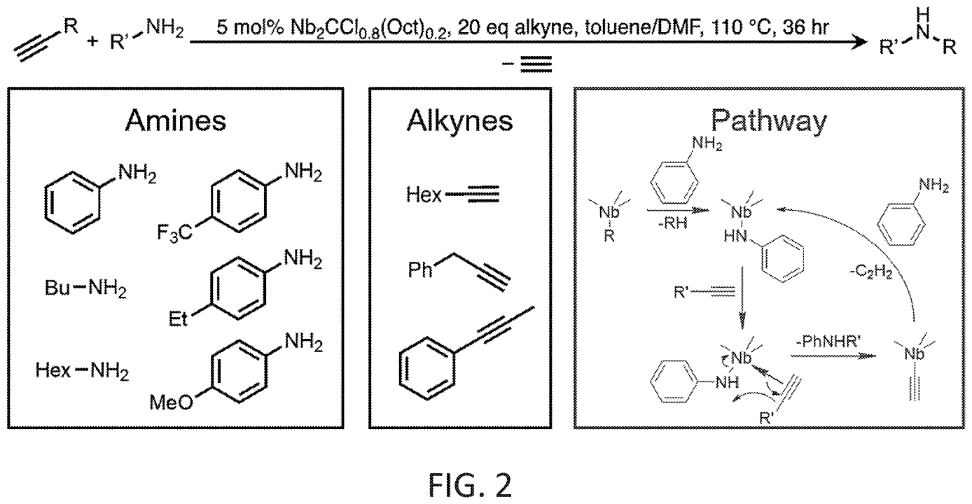

The alkylated MXenes can be used as starting reactants for further substitutions of the surface terminating alkyl groups or as catalysts. For example, the alkylated MXenes can serve as C—N coupling catalysts for the addition of ammonia or primary or secondary amines to non-activated alkenes and alkynes. The amines can be aliphatic or aromatic amines. These catalyzable addition reactions are an efficient route to the formation of higher substituted nitrogen-containing products. The use of the alkylated MXenes as C—N coupling catalysts is illustrated in Example 3, below, using an octyl functionalized Nb₂C MXene as a representative alkylated MXene. During C—N coupling, the N—H bond of ammonium or amine is added across a double or triple bond. Non-limiting examples of amines and alkynes that can be reacted in a C—N coupling, along with a proposed catalytic reaction pathway are shown in FIG. 2. The specific alkylated MXene, solvents, and reaction temperatures and times shown in the figure are for illustrative purposes only. Other alkylated MXenes, solvents, and reaction temperatures and times can be used.

### Examples

### Example 1. This Example Illustrates the Direct Synthesis of Carbide MXenes Using Alkyl Halide Reactants

Ti₂CCl₂, Ti₂CBr₂, Zr₂CCl₂, Zr₂CBr₂, Nb₂CCl₂ and Nb₂CBr₂ MXenes (denoted as “DS-MXenes”) were directly synthesized through high-temperature reactions between hydrogenated transition metal powders and DCM or DBM. (Hydrogenated transition metals can be in the form of commercial hydrided metal, a regular metal with added LiH, or by running the reaction under hydrogen atmosphere.)

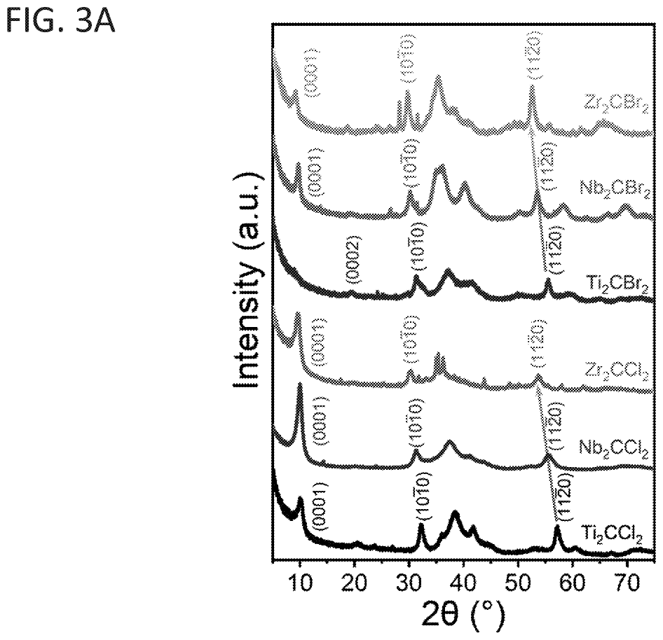

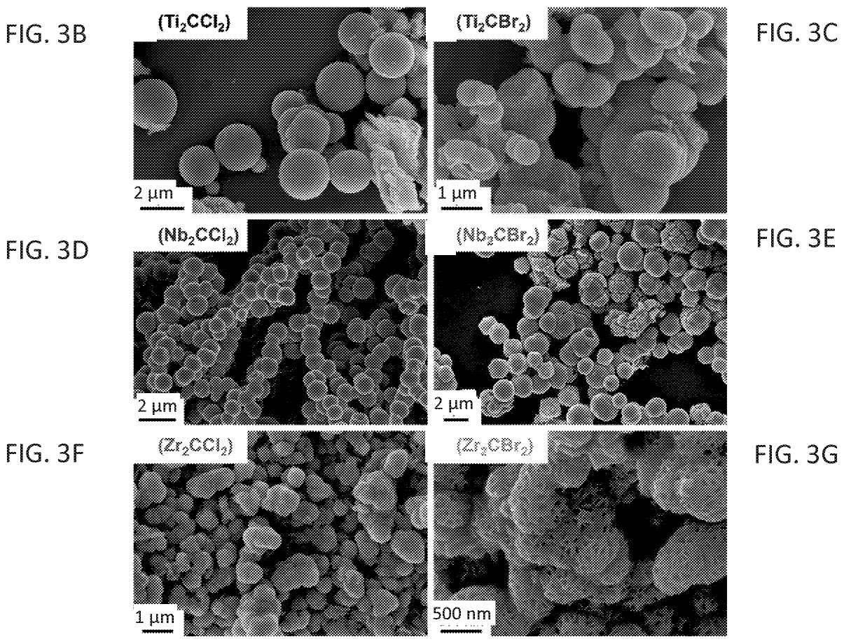

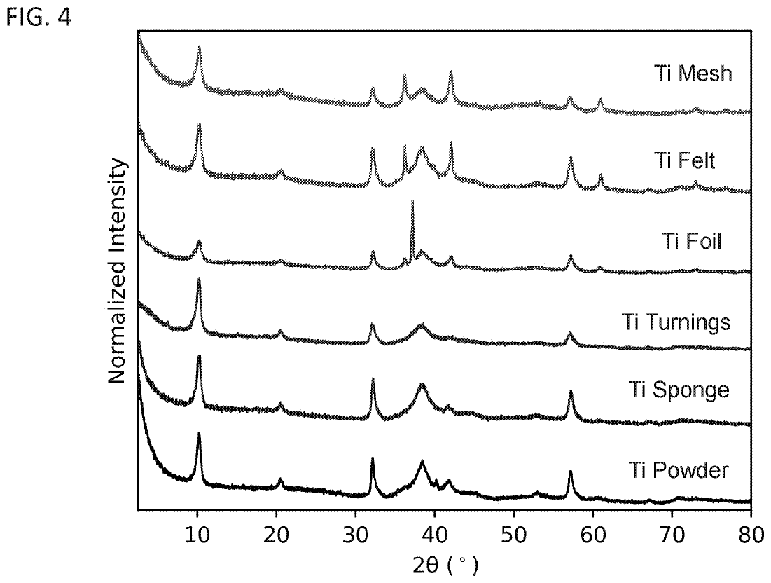

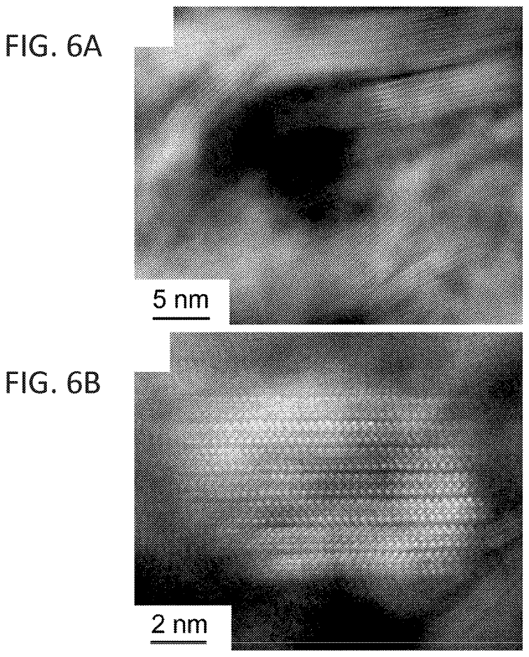

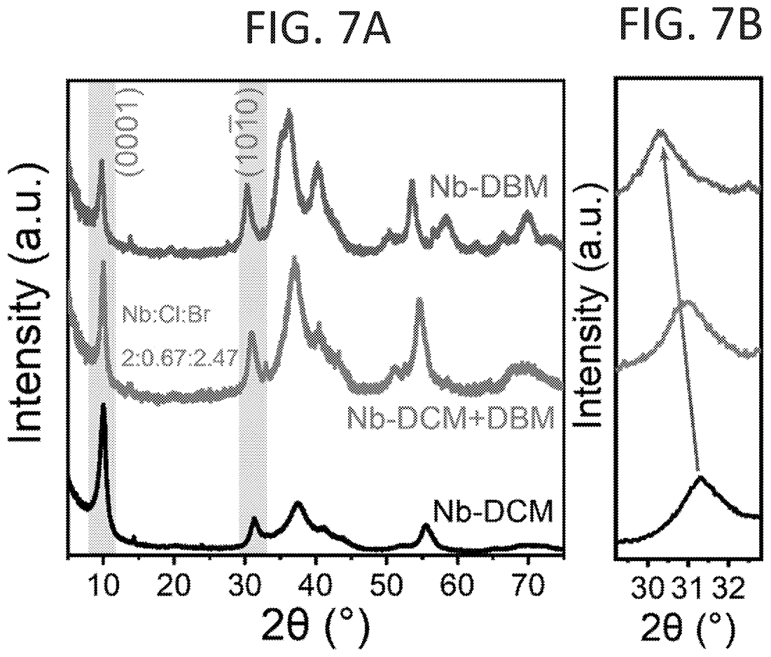

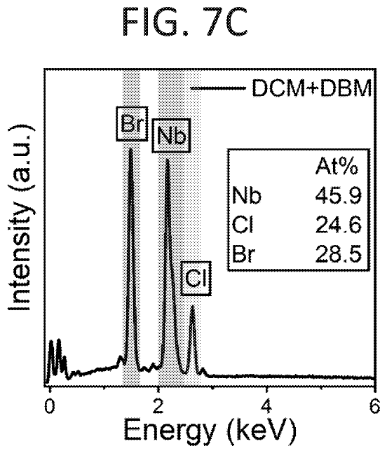

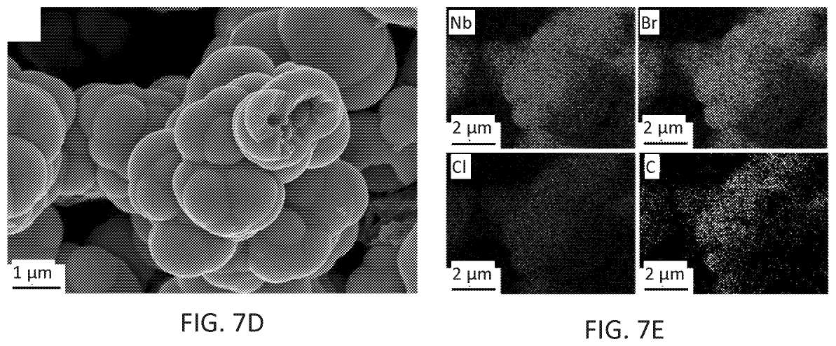

DCM and DBM, which are the reduced forms of “CCl₂” and “CBr₂” units, provided a spontaneous reducing atmosphere. The reaction of Ti, Zr, or Nb powders, sponge, or other metal precursors with DCM or DBM gave a full collection of M₂CX₂ MXenes, where M=Ti, Zr, or Nb and X═Cl or Br (FIGS. 3A-3G, FIG. 4, FIGS. 5A-5E). The DS-MXenes synthesized from DCM or DBM showed high phase purity, based on XRD (FIG. 4). The usage of DBM also enabled the direct synthesis of Ti₂CBr₂ MXenes (FIGS. 6A-6B). Ti₂CBr₂ is a strained phase, showing a weak out-of-plane diffraction signal. The use of a combination of DCM and DBM produced MXenes with Cl and Br mixed terminal groups (FIGS. 7A-7E).

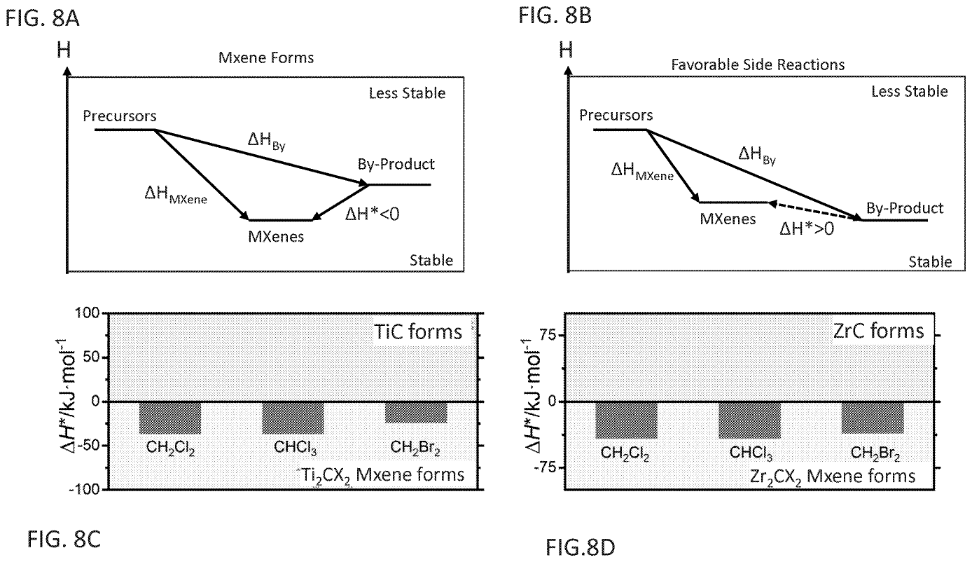

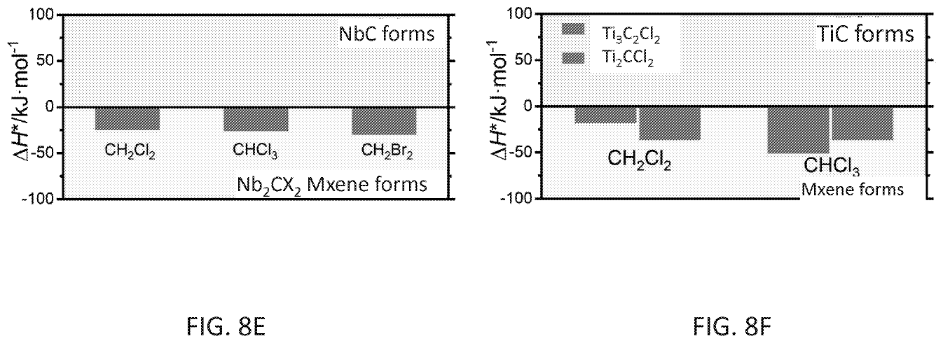

DFT calculations were performed to investigate the thermodynamics of the reactions involving a transition metal M=Ti, Zr, or Nb and DCM or DBM. The entropy contributions of these reactions were mostly minimal or cancelled each other out, thus the calculations focused on the standard enthalpy (ΔH) of reactions. A general trend emerged whereby, when a transition metal M was reacted with lower-valence organohalides DCM or DBM (FIGS. 8A-8F), the side reactions forming a transition metal carbide MC by-product phase were energetically less favorable than the formation of the M₂CX₂ MXenes (X═Cl, Br).

### Materials and Methods

### Chemicals and Materials

Hydrided Ti powder (Ti(H)), containing 3.90 weight percent (wt. %) of H that corresponds to a nominal composition TiH_{1.94} (~325 mesh, 99%), was purchased from Thermo Fisher Scientific. Titanium sponge (28.4 mm & down, 99.7%), titanium foil (0.127 mm thick, annealed, 99.99+%), titanium powder (~325 mesh, 99.5%), and titanium gauze mesh (80 mesh woven from 0.13 mm diameter wire) were purchased from Thermo Fisher Scientific. Titanium fiber felt (5×5 cm) was purchased from Fuel Cell Store. Titanium turnings and shavings (Ti-6Al-4V, nominal composition 6 wt. % Al and 4 wt. % V) were purchased from eBay and rinsed with hexanes and/or acetone to remove residual cooling fluid, then dried in a vacuum oven prior to use.

CH₂Cl₂ (anhydrous, >99.8%, containing amylene as a stabilizer), CH₂Br₂ (stabilized, 99%), and N-methyl formamide (NMF, 99%) were purchased from Sigma. NMF was purified by distillation before handling in a glovebox.

Zirconium powder (-50 mesh, 99.5%), and niobium powder (~325 mesh, 99.8%) were purchased from Strem Chemicals. Fused quartz tubes (10 mm O.D., 8 mm I.D.) and rods (7 mm O.D.) for ampoule fabrication were purchased from Technical Glass Products, Inc. Ar gas (ultra-high purity grade), and Ar/H₂ gas (5% hydrogen, ultra-high purity grade) were purchased from Airgas.

Direct Synthesis of M₂CX₂ MXenes Using CH₂Cl₂ and CH₂Br₂ (M=Ti, Zr, or Nb; X═Cl and/or Br).

M₂CX₂ MXenes were synthesized by the reaction of elemental M powder with CH₂Cl₂ or CH₂Br₂. All the syntheses were conducted under Ar atmosphere in a dry glove box unless otherwise noted.

Ti₂CCl₂ and Ti₂CBr₂: commercial hydrided Ti powder was transferred into a quartz test tube using a glass funnel, followed by the addition of 0.650 molar equivalents of CH₂Cl₂ or CH₂Br₂. The test tube was chilled with liquid nitrogen to reduce loss of CH₂Cl₂ or CH₂Br₂ to vaporization and sealed under vacuum. To initiate the reaction, the ampoules were put inside a muffle furnace and heated to 800° C. (725° C. for Ti₂CBr₂) in 10 min. The temperature was maintained for 24 hours until the reaction was finished. The ampoules were then cooled to room temperature by switching off the furnace.

Zr₂CCl₂ and Zr₂CBr₂: Zr powder was transferred into a quartz test tube using a glass funnel, followed by the addition of 0.650 molar equivalent of CH₂Cl₂ or CH₂Br₂. The test tube was chilled by liquid nitrogen to reduce loss of CH₂Cl₂ or CH₂Br₂ to vaporization and sealed under vacuum. To initiate the reaction, the ampoules were put inside a muffle furnace and heated to 800° C. (750° C. for Zr₂CBr₂) in 10 min. The temperature was maintained for 24 hours until the reaction was finished. The ampoules were then naturally cooled to room temperature by switching off the furnace.

Nb₂CCl₂ and Nb₂CBr₂: Nb powder was transferred into a quartz test tube using a glass funnel, followed by addition of 0.650 molar equivalent of CH₂Cl₂ or CH₂Br₂. The test tube was chilled by liquid nitrogen to reduce loss of CH₂Cl₂ or CH₂Br₂ to vaporization and sealed under vacuum. To initiate the reaction, the ampoules were put inside a muffle furnace and heated to 830° C. (750° C. for Nb₂CBr₂) in 10 min. The temperature was maintained for 24 hours until the reaction was finished. The ampoules were then naturally cooled to room temperature by switching off the furnace.

Chemical vapor deposition synthesis of M₂CX₂ MXenes using CH₂Cl₂ and CH₂Br₂ (M=Ti, Zr, or Nb; X Cl and/or Br): M₂CX₂ MXenes were_synthesized using Ti powder, Ti sponge, a Ti foil, a Ti felt, and a Ti mesh as a starting material. The early-transition metal starting material was placed in an inert boat (e.g., alumina or boron nitride) and loaded into the center of the tube furnace. The system was sealed and placed under vacuum for 1 hour followed by refilling the system with an inert gas, e.g., Ar. This cycle was repeated three times to ensure the reaction was done under inert atmosphere. To begin the reaction, the furnace was heated up to the reaction temperature while flowing 100 standard cubic centimeters per minute (SCCM) of pure inert gas for 20 minutes. Then, the inert gas was bubbled into the desired alkyl halide. This initiates the reaction between the metal precursor and the alkyl halide vapor. At low flow rates (e.g., 2 SCCM of CH₂Cl₂), the reaction was slow enough to grow MXenes mainly on the surface. After prolonged flow at 2 SCCM, all of the metal precursor was consumed yielding MXene powder only. Alternatively, higher flow of 10 SCCM can be used if pure MXene powder is desired to decrease reaction time. Reaction times vary depending on the mass of the starting metal precursor. Often reactions using around 200 mg of metal powder require roughly 1 hour at 10 SCCM of DCM flow to complete.

FIG. 4 shows XRD patterns of the Ti₂CCl₂ products after reacting with the CH₂Cl₂ at 830° C. XRD patterns of Ti foil, felt, and mesh are run at 2 SCCM Ar into DCM yielding MXene carpets on the surface of each substrate. This is evidenced by the existence of Ti metal in the XRD patterns of each form of the Ti starting material. The Ti powder, sponge, and turnings (the turnings are discussed in more detail in Example 2, below) were synthesized with a higher flow rate of 10 SCCM Ar into DCM to yield pure MXene powders. These had no visible Ti metal in XRD as they were fully reacted to form MXenes.

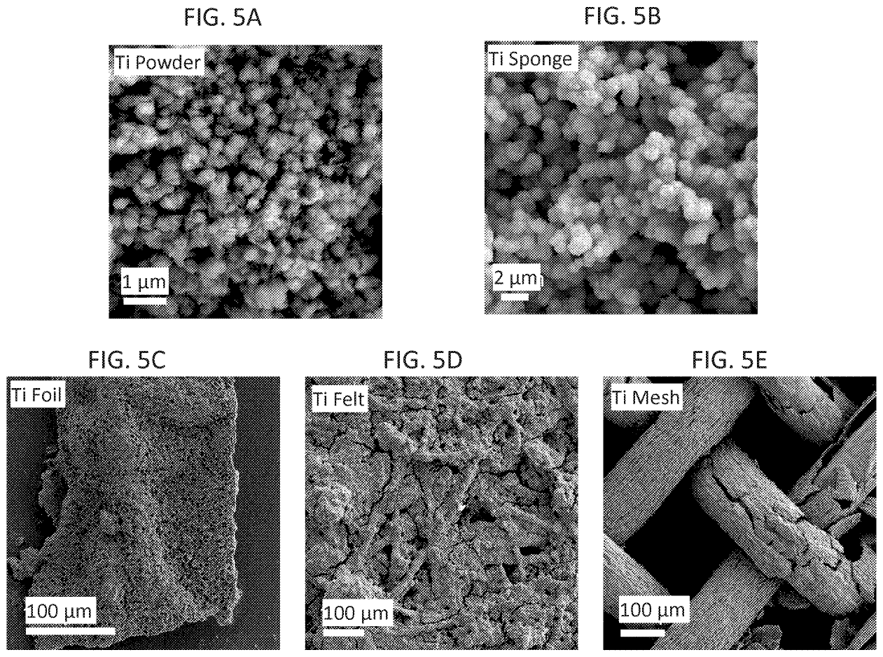

FIGS. 5A-5E show SEM images of final Ti₂CCl₂ MXenes after reacting with CH₂Cl₂ at 830° C. from starting titanium sources: Ti powder (FIG. 5A), Ti sponge (FIG. 5B), Ti foil (FIG. 5C), Ti felt (FIG. 5D), and Ti mesh (FIG. 5E).

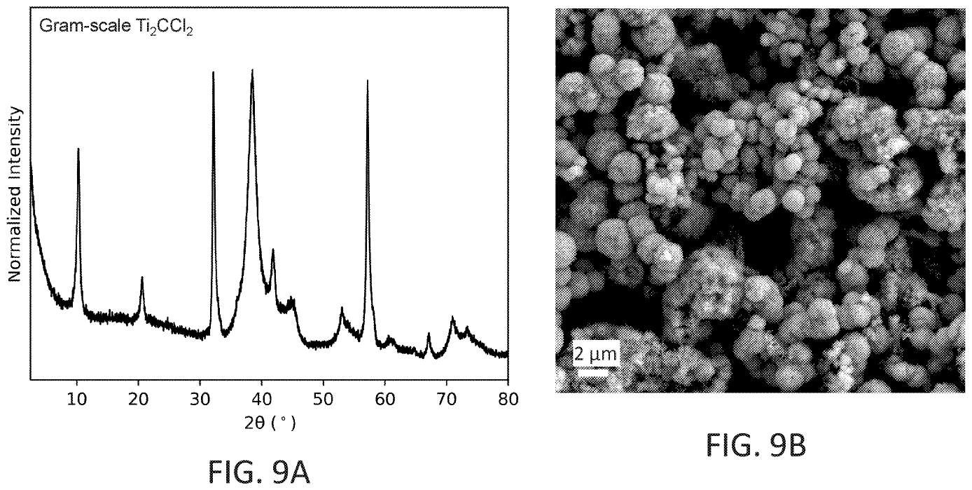

FIG. 9A shows an XRD pattern of Ti₂CCl₂ synthesized from 2 g of titanium sponge and excess CH₂Cl₂ at 830° C. for 6 hours. FIG. 9B shows an SEM image of the gram-scale Ti₂CCl₂ product.

### Dispersion of DS-MXene in Polar Organic Solvents

DS-MXenes could be easily dispersed in polar organic solvents such as DMF, NMF and propylene carbonate (PC) by hand shaking. The use of NMF gives the best colloidal stability of DS-MXene particles. As an example, 100 mg DS-Ti₂CCl₂ was immersed in 5 mL NMF inside the N₂ filled glovebox. After hand shaking or vortexing, the supernatant was collected after centrifuging at 240 g for 15 minutes to remove most insoluble by-products. Finally, the supernatant containing the MXenes was centrifuged at 12100 g for 15 minutes to precipitate the MXenes, leaving small impurities in solution. The sediment was redispersed in fresh NMF to form a stable colloidal solution (up to 70 g·L⁻¹) of DS-Ti₂CCl₂ MXene.

### Characterization Methods

The structure and composition of MXenes were characterized using x-ray characterization, Raman spectroscopy, electron microscopy and a combination of energy dispersive x-ray spectroscopy (EDX) and electron energy-loss spectroscopy (EELS) analyses.

### XRD

The diffraction patterns in Bragg-Brentano geometry were obtained using a Rigaku benchtop X-ray diffractometer equipped with HyPix-400 MF 2D hybrid pixel array detector (HPAD) and a Cu Kα X-ray source (1.5406 A) operating at 40 kV and 15 mA.

XRD full-pattern fitting (Rietveld refinement) was performed using Bruker TOPAS Version 5 software. The Ti₂CCl₂ MXene samples were assumed to contain two major phases: Ti₂CCl₂ MXene (space group P-3 m1) and TiCₓ (space group Fm-3m). The Stephens model (trigonal symmetry) was used to account for the anisotropic peak broadening of the XRD patterns of the MXene phases.

### Scanning Electron Microscopy-Energy Dispersive X-Ray Spectroscopy (SEM-EDX)

SEM imaging and EDX elemental mapping were performed in a Carl Zeiss Merlin Field-Emission Scanning Electron Microscope equipped with Oxford Ultim Max 100 Silicon Drift Detectors (SDD). The accelerating voltage was set to 10 kV and beam current was set to 1 nA.

### Scanning Transmission Electron Microscopy (STEM)

Atomic-resolution characterization of the MXene samples was conducted using aberration-corrected scanning transmission electron microscope (STEM) imaging and spectroscopy experiments at the University of Illinois Chicago. The JEOL JEM-ARM200CF microscope is equipped with a cold-field emission electron gun operated at 200 kV, and a probe-forming aberration corrector. A probe convergence semi-angle of 28 mrad was used, resulting in a spatial resolution of 73 pm for imaging and spectrum imaging. The emission current was reduced to 14 μA to minimize damage from the electron beam. Under these conditions, an energy resolution of 350 meV can be achieved. The inner and outer acceptance angles for the annular detectors were set to 68 mrad and 280 mrad for high-angle annular dark-field (HAADF) imaging and to 40 mrad and 160 mrad for low-angle annular dark-field (LAADF) imaging. A post-column Gatan Continuum imaging filter was used for EELS and an Oxford XMAX100TLE X-ray detector for EDX analysis. The EDX spectra were collected with a pixel dwell time of 120 μs per pixel analysis. The EDX data were then processed using AZtec software to quantify the elemental composition with a binning factor of 2. The MXene powder was dispersed in NMF, a polar solvent, to form a colloidal solution. The particles were then drop-cast onto a 3 mm diameter TEM mesh grid covered with holey carbon. The grid was left to dry in a N₂ glovebox for 2 hours. Subsequently, the samples were transferred from the glovebox into the microscope column using an air-free transfer workflow.

### Computational Details

Density function theory (DFT) total-energy calculations and geometry optimization of the MXene systems were performed using the Vienna ab initio Simulation Package (VASP) (Kresse, G. et al., Computational Materials Science 1996, 6 (1), 15-50.) The Perdew-Burke-Ernzerhof (PBE) functional within the generalized gradient approximation (GGA) was used for electron exchange-correlation. (Perdew, J. P. et al., Physical Review Letters 1996, 77 (18), 3865-3868.) Projector-Augmented Wave (PAW) potential was used treat the electron-ion interaction. (Blochl, P. E., B 1994, 50 (24), 17953-17979.) The DFT-D3 method was employed to account for van der Waals interactions. (Grimme, S. et al., Journal of Computational Chemistry 2011, 32 (7), 1456-1465.) Spin-polarized calculations were performed, with a planewave energy cutoff of 500 eV. All atomic coordinates were relaxed until the total energy converged to within 10⁻⁶ eV per atom and atomic force to within 0.01 eV Å⁻¹. A 9×9×1 Γ-centered k-point mesh was used to sample the Brillouin zones of the MXene layers with a slab model of sufficient vacuum thickness (~15 Å).

### Purity of MXenes Based on Weight Percentage

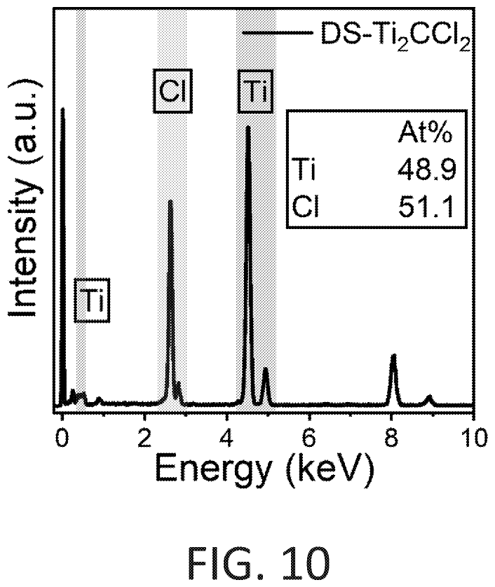

The purity of the MXene (e.g., DS-Ti₂CCl₂) in the product of the direct synthesis, based on weight percent was determined based on combustion elemental analysis by Atlantic Microlab, Inc. The samples were carefully washed with hydrochloric acid, water, and ethanol to remove all soluble by-products, then vacuum dried before testing. Very low hydrogen content established that the samples had been dried properly. The weight percentage of the transition metal (e.g., Ti) was calculated based on the metal:halogen (e.g., Ti:Cl) ratio from SEM-EDX analysis of the MXenes (FIG. 10).

Using DS-Ti₂CCl₂ as an illustrative example: according to the Rietveld refinement results, only two crystalline phases were present: the MXene phase and a TiCₓ phase. The Ti:CI atomic ratio within MXene flakes was found to be close to 1:1 by STEM-EDX analysis (FIG. 10). Based on this, the wt. % of MXene was calculated by based on the MXene phase the the only component that contained Cl and the stoichiometry of the MXene phase being Ti₂CCl₂. (For this purity calculation, an DS-Ti₂CCl₂ MXene made using C2Cl4 as a reactant was used. However, this purity calculation methodology can also be applied to the MXenes made using alkyl halide reactants.)

$$MXene phase Purity : wt \% ( MXene ) = wt \% ( Cl ) / {M}_{r} ( Cl ) * {M}_{r} [ {( {Ti}_{2} {CCl}_{2} )}_{1 / 2} ]$$

TABLE 1
Weight percentage of Ti₂CCl₂ when Ti and C₂Cl₄ were used as precursor.
DS-Ti₂CCl₂ (MXene) elemental analysis

| Element | Cl | C | H | Ti (based on an EDX ratio) | others |
|---|---|---|---|---|---|
| wt % | 34.93 | 7.36 | 0.24 | 51.94 | 5.53 |

The product of the direct synthesis had an MXene phase purity of Ti₂CCl₂: 88.14 wt. %.

### Calculation of Enthalpy of Reactions

The thermodynamics of reactions by reacting a transition metal M=Ti, Zr, or Nb and an alkyl halide precursor were screened by comparing the energy differences between forming MXenes phases with the most competitive side reactions producing cubic MC carbide phases. In most of these reactions, the numbers of gas molecules remain unchanged or can be cancelled in comparison, suggesting minimal entropy contributions in flipping the product selectivity. Therefore, the energy of involved chemical species (E) was calculated, and the enthalpy changes of reactions (ΔH) were derived.

Note: The E values of the listed chemical species were used to calculate the enthalpy changes. However, these values may differ from the standard enthalpy of formation, as they were directly derived from DFT calculation results, rather than referenced to the most stable or common elemental form as required by the definition of standard enthalpy of formation. Nonetheless, this discrepancy is just a matter of baseline adjustment and should not affect the calculation of ΔH significantly.

The values of ΔH are also normalized to the number of M in the chemical reaction, in order compare the feasibility of different alkyl halides as precursors of MXene direct synthesis.

The initial states were fixed to the stoichiometries that are expected to provide the best yields given below:
2M+CH₂Cl₂→MXenes vs. MC
2M+CHCl₃→MXenes vs. MC
2M+CH₂Br₂→MXenes vs. MC
   Note: the 30% excess amounts of alkyl halides in the synthetic experiments were to compensate for their decomposition and evaporation during a flame sealing process.

TABLE 2
Energy of chemical species. Results are based on DFT calculations
at 0 K. Energy of MXenes were derived based on single layers.

| Metals and carbides | E/kJ · mol⁻¹ | TM halides | E/kJ · mol⁻¹ | Small molecules | E/kJ · mol⁻¹ |
|---|---|---|---|---|---|
| Ti (s) | −815 | TiCl₄ (g) | −2262 | CH₂Cl₂ (g) | −2020 |
| Zr (s) | −874 | TiCl₃ (g) | −1797 | CHCl₃ (g) | −1864 |
| Nb (s) | −1057 | TiCl₂ (s) | −1607 | C₂Cl₄ (g) | −2531 |
| Ti₂CCl₂ (s) | −3573 | TiBr₄ (g) | −2015 | C₂Cl₆ (g) | −2990 |
| Zr₂CCl₂ (s) | −3755 | TiBr₃ (g) | −1613 | CCl₄ (g) | −1691 |
| Nb₂CCl₂ (s) | −3865 | TiBr₂ (s) | −1471 | Cl₂ (g) | −348 |
| Ti₂CBr₂ (s) | −3412 | ZrCl₄ (g) | −2404 | HCl (g) | −589 |
| Zr₂CBr₂ (s) | −3615 | ZrCl₃ (g) | −1875 | CH₂Br₂ (g) | −1897 |
| Nb₂CBr₂ (s) | −3730 | ZrCl₂ (s) | −1717 | CBr₄ (g) | −1439 |
| Ti₃C₂Cl₂ (s) | −5466 | ZrBr₄ (g) | −2152 | Br₂ (g) | −293 |
| Zr₃C₂Cl₂ (s) | −5719 | ZrBr₃ (g) | −1686 | HBr (g) | −521 |
| Nb₃C₂Cl₂ (s) | −5885 | ZrBr₂ (s) | −1588 | H₂ (g) | −653 |
| TiC (s) | −1892 | Nb₂Cl₁₀ (g) | −5320 | CH₄ (g) | −2322 |
| ZrC (s) | −1956 | Nb₂Cl₆ (g) | −3855 | C₂H₄Cl₂ (g) | −3634 |
| NbC (s) | −2077 | NbCl₂ (s) | −1736 | | |
| C (α-graphite) | −904 | Nb₂Br₁₀ (g) | −4702 | | |
| | | Nb₂Br₆ (g) | −3503 | | |
| | | NbBr₂ (s) | −1594 | | |

TABLE 3
Enthalpy of different reactions (ΔH) when transition metals Ti, Zr, or Nb react with CH₂Cl₂.

| | | ΔH/kJ · | ΔH per | |
|---|---|---|---|---|
| No. | Reactions | mol⁻¹ | M/kJ · mol⁻¹ | ΔS |
| 1 | 2 Ti (s) + CH₂Cl₂ (g) = Ti₂CCl₂ (s) + H₂ (g) | −575 | −288 | / |
| 2 | 2 Zr (s) + CH₂Cl₂ (g) = Zr₂CCl₂ (s) + H₂ (g) | −641 | −320 | / |
| 3 | 2 Nb (s) + CH₂Cl₂ (g) = Nb₂CCl₂ (s) + H₂ (g) | −383 | −191 | / |
| 4 | 2 Ti (s) + CH₂Cl₂ (g) = TiC (s) + TiCl₂ (s) + H₂ (g) | −502 | −251 | / |
| 5 | 2 Zr (s) + CH₂Cl₂ (g) = ZrC (s) + ZrCl₂ (s) + H₂ (g) | −558 | −279 | / |
| 6 | 2 Nb (s) + CH₂Cl₂ (g) = NbC (s) + NbCl₂ (s) + H₂ (g) | −331 | −166 | / |
| 10 | 4 Ti (s) + 2 CH₂Cl₂ (g) = Ti₃C₂Cl₂ (s) + TiCl₂ (s) + 2 H₂ (g) | −1078 | −269 | / |
| 11 | 4 Zr (s) + 2 CH₂Cl₂ (g) = Zr₃C₂Cl₂ (s) + ZrCl₂ (g) + 2 H₂ (g) | −1206 | −302 | / |
| 12 | 4 Nb (s) + 2 CH₂Cl₂ (g) = Nb₃C₂Cl₂ (s) + NbCl₂ (g) + 2 H₂ (g) | −657 | −164 | / |

In ΔS, “/” indicates the total number of gas molecules remains unchanged during the reaction, suggesting a minimal entropy contribution.

TABLE 4
Enthalpy of different reactions (ΔH) when transition metals Ti, Zr, or Nb react with CHCl₃.

| | | ΔH/kJ · | ΔH per | |
|---|---|---|---|---|
| No. | Reactions | mol⁻¹ | M/kJ · mol⁻¹ | ΔS |
| 1 | 2 Ti (s) + CHCl₃ (g) = Ti₂CCl₂ (s) + HCl (g) | −668 | −334 | / |
| 2 | 2 Zr (s) + CHCl₃ (g) = Zr₂CCl₂ (s) + HCl (g) | −732 | −367 | / |
| 3 | 2 Nb (s) + CHCl₃ (g) = Nb₂CCl₂ (s) + HCl (g) | −476 | −238 | / |
| 4 | 2 Ti (s) + CHCl₃ (g) = TiC (s) + TiCl₂ (s) + HCl (g) | −594 | −297 | / |
| 5 | 2 Zr (s) + CHCl₃ (g) = ZrC (s) + ZrCl₂ (s) + HCl (g) | −650 | −325 | / |
| 6 | 2 Ti (s) + CHCl₃ (g) = NbC (s) + NbCl₂ (s) + HCl (g) | −424 | −212 | / |
| 7 | 4 Ti (s) + 2 CHCl₃ (g) = Ti₃C₂Cl₂ (s) + TiCl₄ (s) + H₂ (g) | −1392 | −348 | −1 |
| 8 | 4 Zr (s) + 2 CHCl₃ (g) = Zr₃C₂Cl₂ (s) + ZrCl₄ (s) + H₂ (g) | −1552 | −388 | −1 |
| 9 | 24 Nb (s) + 12 CHCl₃ (g) = 6 Nb₃C₂Cl₂ (s) + 2 NbCl₂ (s) + 2 | −5596 | −233 | −4 |
| | Nb₂Cl₁₀ (g) + 6 H₂ (g) | | | |

In the ΔS column, “/” indicates the total number of gas molecules remains unchanged during the reaction, suggesting a minimal entropy contribution. “—” indicates the total number of gas molecules decreases during the reaction, suggesting a potential entropy factor to make the reaction less favorable at higher temperatures.

TABLE 5
Enthalpy of different reactions (ΔH) when transition
metals Ti, Zr, or Nb react with CH₂Br₂.

| | | ΔH/kJ · | ΔH per M/ | |
|---|---|---|---|---|
| No. | Reactions | mol⁻¹ | kJ · mol⁻¹ | ΔS |
| 1 | 2 Ti (s) + CH₂Br₂ (g) = Ti₂CBr₂ (s) + H₂ (g) | −538 | −269 | / |
| 2 | 2 Zr (s) + CH₂Br₂ (g) = Zr₂CBr₂ (s) + H₂ (g) | −623 | −312 | / |
| 3 | 2 Nb (s) + CH₂Br₂ (g) = Nb₂CBr₂ (s) + H₂ (g) | −371 | −186 | / |
| 4 | 2 Ti (s) + CH₂Br₂ (g) = TiC (s) + TiBr₂ (s) + H₂ (g) | −489 | −245 | / |
| 5 | 2 Zr (s) + CH₂Br₂ (g) = ZrC (s) + ZrBr₂ (s) + H₂ (g) | −552 | −276 | / |
| 6 | 2 Nb (s) + CH₂Br₂ (g) = NbC (s) + NbBr₂ (s) + H₂ (g) | −313 | −156 | / |

In the ΔS column, “/” indicates the total number of gas molecules remains unchanged during the reaction, suggesting a minimal entropy contribution.

### Example 2: This Example Illustrates the Direct Synthesis of a Mixed Metal MXenes Using a Metal Allow Starting Material and Alkyl Halide Reactants

To demonstrate the synthesis of a mixed metal MXene from an inexpensive early transition metal starting material, MXenes incorporating Ti and V was synthesized from a scrap metal Ti-6Al-4V turnings. The MXenes, which are designated “(Ti, V)₂CCl₂” MXenes were synthesized using CVD with a CH₂Cl₂ precursor, as described in Example 1.

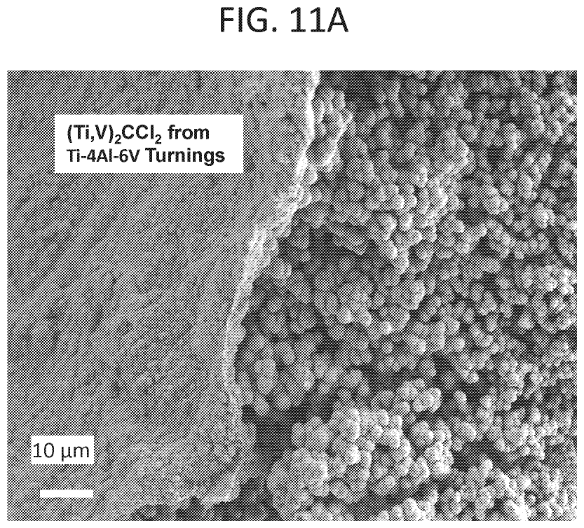

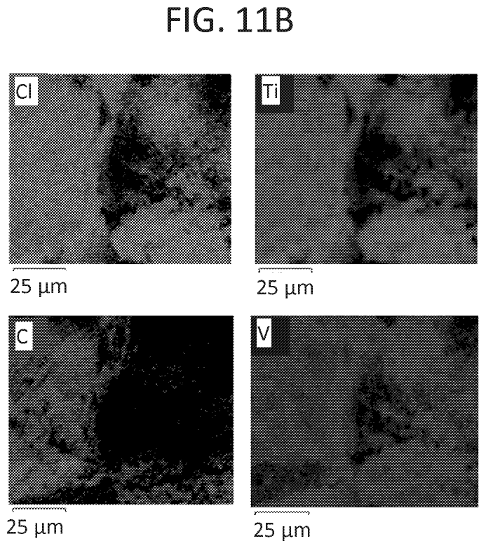

FIG. 11A shows an SEM image of (Ti, V)₂CCl₂ MXenes made from the Ti-6Al-4V turnings. FIG. 11B is an EDX map showing that the (Ti, V)₂CCl₂ MXenes had a V contact of 1 at. % V. This demonstrates early transition metal alloy starting materials can produce mixed metal MXenes using the methods disclosed herein.

### Example 3. This Example Illustrates the Alkylation of MXenes by Electrochemical Processes and their Use as C—N Coupling Catalysts

By tuning the reductive potential applied to a Ti₂CCl₂ MXene electrode soaked in tetrabutylammonium (TBA) chloride acetonitrile electrolyte, MXenes were intercalated by TBA or got reduced to eliminate terminal Cl atoms. The most interesting observation was the substitution of surface Cl with butyl groups, forming butyl terminated MXenes.

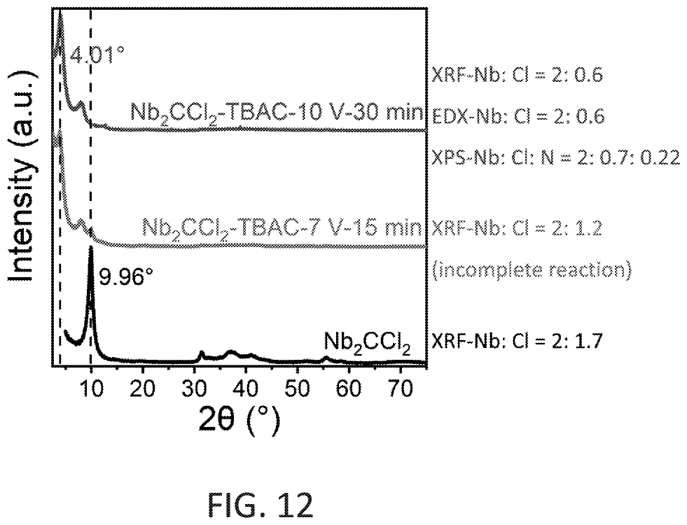

Take the synthesis of butyl terminated M₂CCl₂ (M=Ti or Nb) MXenes as an example. First, MXenes were fully intercalated by tetrabutylammonium (TBA⁺). A three-electrode electrochemical cell was used to conduct the intercalation reaction. A copper foil pasted with Nb₂CCl₂ MXene powders, with polyvinylidene fluoride (PVDF) as a binder, and a graphite rod were placed as the anode and cathode, respectively. Non-aqueous Ag/Ag⁺ electrode (0.01 M AgNO₃ and 0.1 M tetrabutylammonium perchlorate in acetonitrile) was used as reference. Tetrabutylammonium chloride (TBAC) in acetonitrile (40 mL; 10 mg·mL⁻¹) served as the electrolyte. The intercalation reaction was performed at a potential of −7 to −10 V vs. Ag/Ag⁺ for 15 to 30 min. The product powders were recovered by dissolving PVDF in N,N-dimethylformamide (DMF). In the meantime, a certain amount of surface Cl groups had been removed, depending on the liability of surface ligand. As an example, MS-Ti₂CCl₂ showed negligible surface removal after an electrolysis of 10 min at −10 V. However, more than half of the Cl groups of Nb₂CCl₂ were removed after full intercalation, leading to an estimated composition of Nb₂CCl_{0.8}(TBA)_{0.2} (FIG. 12).

After the reaction, the center-to-center spacing expanded from the original 8.7 to 21.5 Å for Ti₂CCl₂, and 8.9 to 21.6 Å for Nb₂CCl₂. The ~12.8 Å expansion was the same as TBA⁺ intercalated two-dimensional materials like MoS₂. (Z. Lin et al., Nature 562, 254-258 (2018).) The TBA⁺ intercalated MXenes themselves could also be delaminated and dispersed in DMF after ultrasonication.

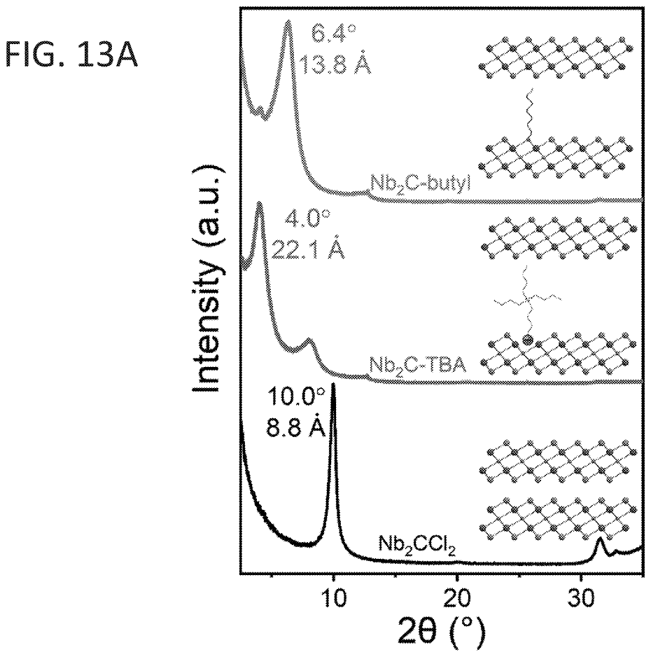

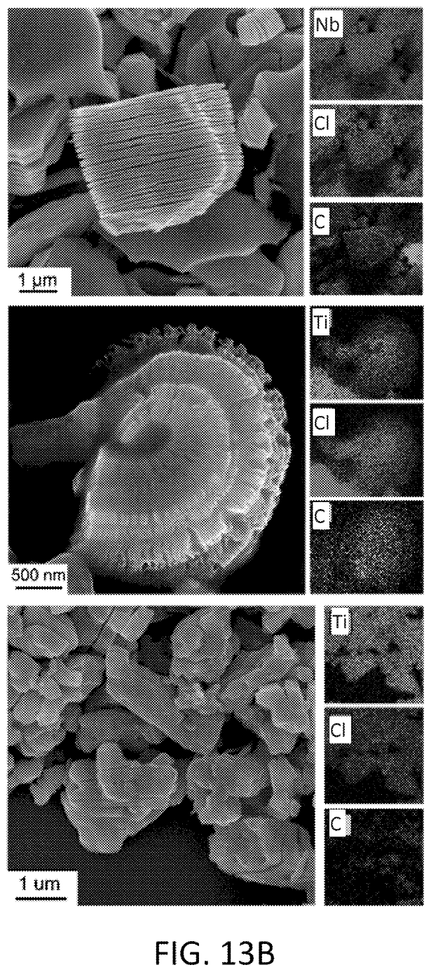

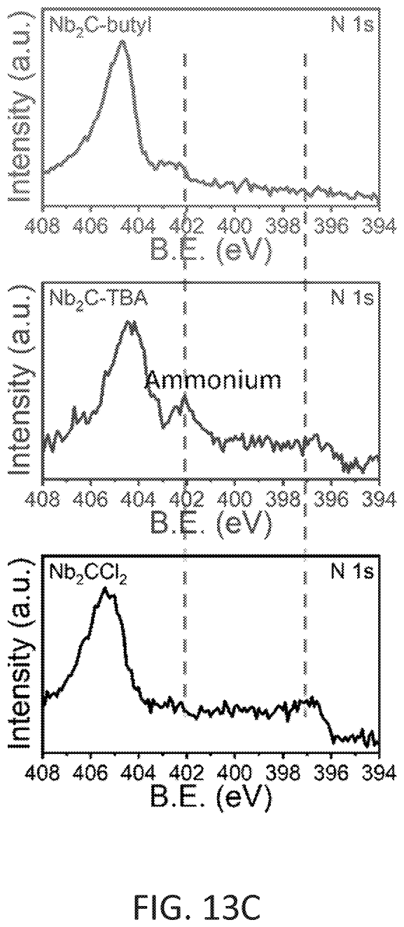

After full intercalation, alkyl transfer could be finished by changing the polarity of the environment. The TBA⁺ intercalated MXenes were precipitated from their DMF suspension by centrifugation at 12100 g for 30 min. The solids were dried, then immersed and stirred in toluene. The low polarity environment crushed the TBA-MXene ionic compound, facilitating the carbocation transfer from TBA⁺ to MXene surfaces. FIG. 13A shows XRD patterns and cartoon structures of Nb₂CCl₂ MXene (starting material), TBA intercalated Nb₂C MXene, and butyl functionalized Nb₂C MXene. FIG. 13B shows SEM images of the corresponding structures. FIG. 13C is a X-ray photoelectron spectroscopy (XPS) N is spectra. A characteristic N+ binding energy was observed in TBA intercalated MXene.

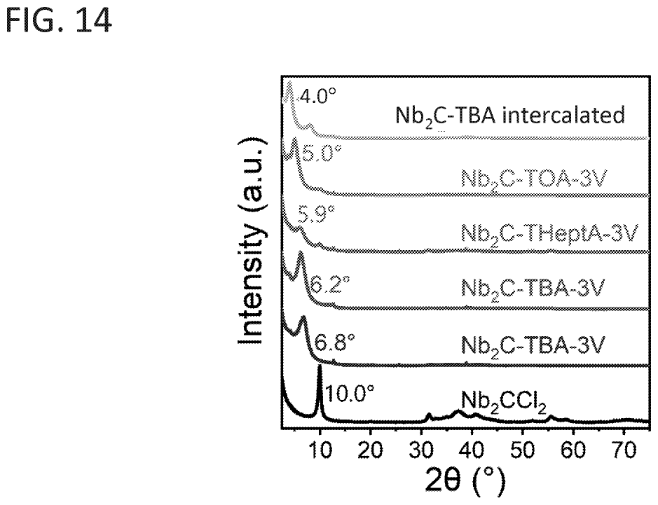

The alkyl incorporation in MXene flakes is supported by a series of analysis such as a change in the center-to-center spacing against a number of carbons in alkyl chains (FIG. 14).

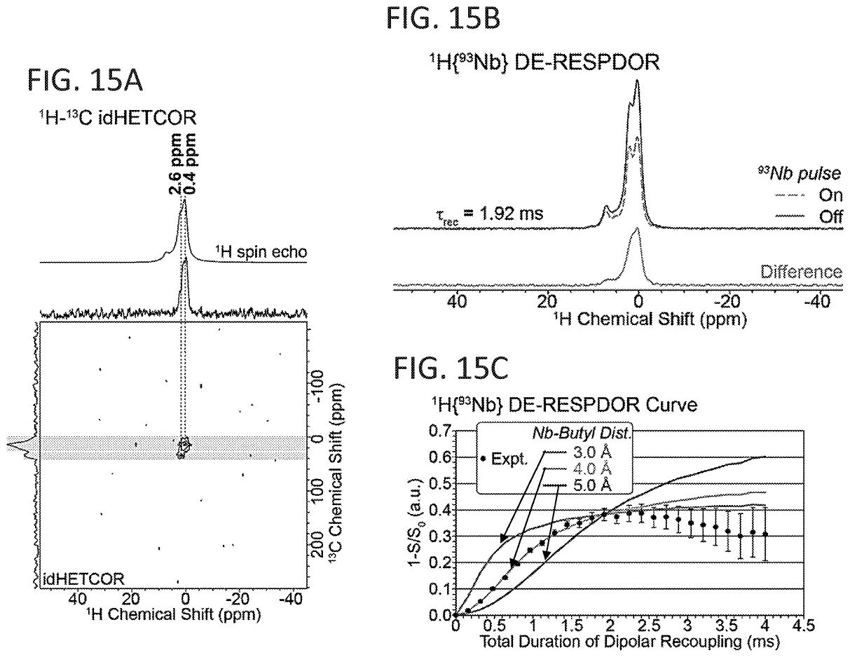

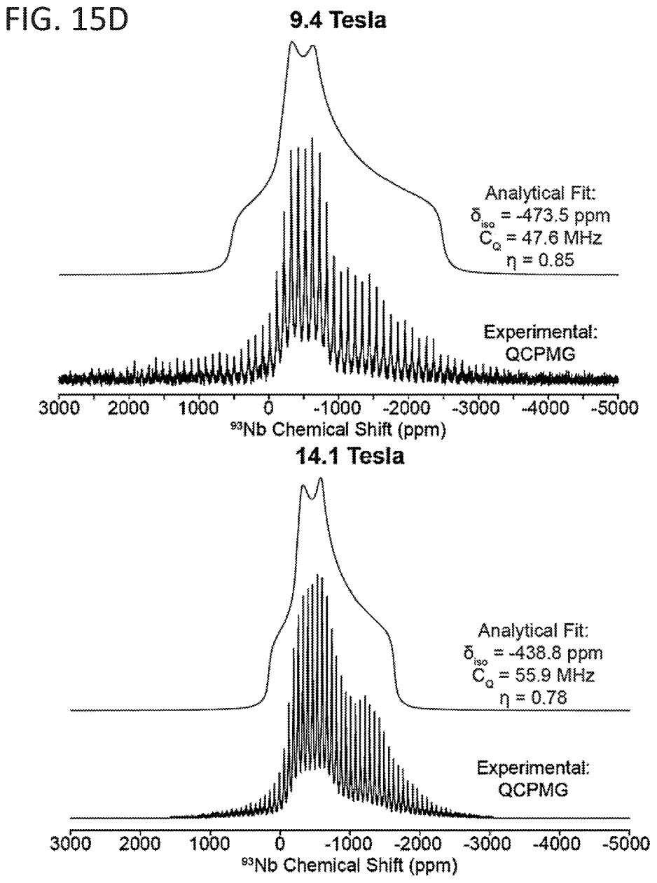

Solid-state nuclear magnetic resonance (ssNMR) spectroscopy confirmed the structure of butyl groups bonded to Nb surfaces (FIGS. 15A-15D).

Sitting on the interface of molecular and solid compounds, the alkyl functionalized MXenes possessed a mixed character and was found capable to initiate unusual reactions (FIG. 2). The addition of ammonia or primary or secondary amine to non-activated alkenes and alkynes, also known as C—N coupling, is an important class of catalyzable reactions because they are potentially the most efficient route to higher substituted nitrogen-containing products. (F. Pohlki, et al., Chemical Society Reviews 32, 104-114 (2003).)

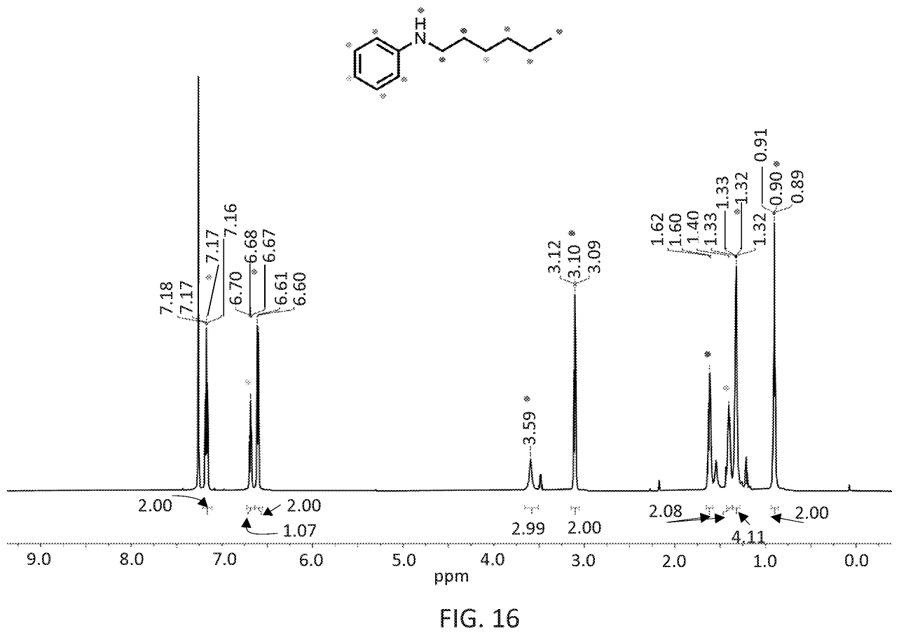

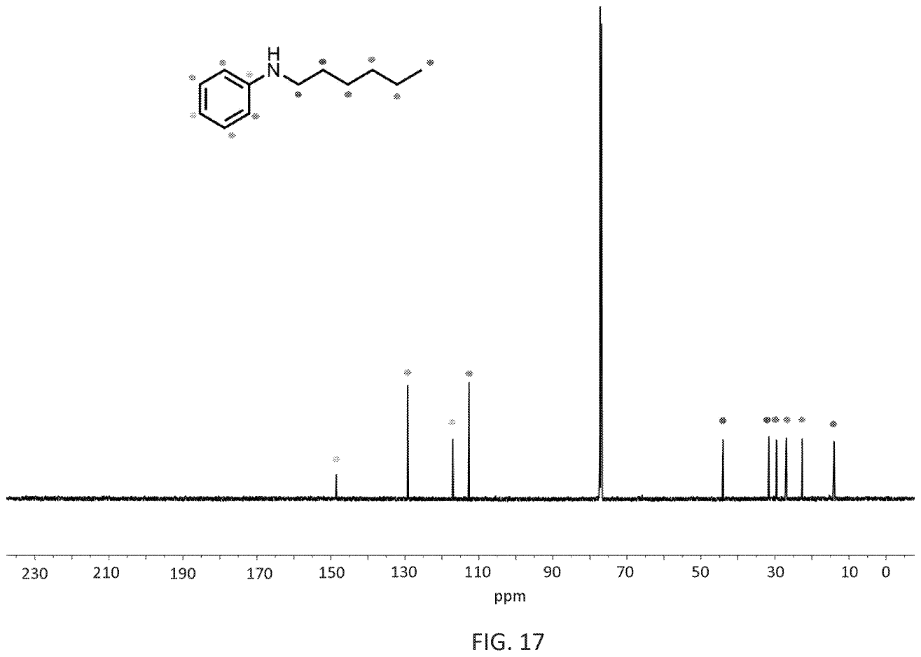

The octyl functionalized Nb₂C MXene was found to be a C—N coupling catalyst with excellent yield and substrate scope. The addition reactions were performed with 5 mol % Nb₂CCl_{0.8}(octyl)_{0.2} MXene, in toluene/DMF at 110° C. for 36 hours (FIG. 2). The product was isolated by gas chromatography (GC) and characterized with NMR (FIGS. 16 and 17) and mass spectroscopy (MS).

### Materials and Methods

### Synthetic Methods

### Chemicals and Materials

Tetraalkylammonium and tetraalkylphosphonium salts were dried under vacuum at 60° C. for at least 24 hours before use. Tetrapentylammonium bromide (99+%) was purchased from Thermo Scientific. Tetraethylammonium bromide (99%), tetrapropylammonium chloride (98%), tetrabutylammonium chloride (TBAC, ≥97.0%), tetrahexylammonium bromide (98%), tetraheptylammonium bromide (99%), tetraoctylammonium bromide (TOAB, 98%), tetrabutylphosphonium bromide (98%), and tetraphenylphosphonium chloride (98%) were purchased from Sigma-Aldrich.

n-butyllithium (n-BuLi, 2.5 M in hexanes), N,N-dimethylformamide (DMF, 99.8%, anhydrous), toluene (99.8%, anhydrous), hexane (95%, anhydrous), MeOH (99.8%, anhydrous), MeCN (99.8%, anhydrous), and NMF(99%) were purchased from Sigma. NMF was purified by distillation before handling in a glovebox.

### Electrochemical Grafting of MXenes

A two-electrode electrochemical cell was used to conduct the intercalation. A copper foil pasted with Ti₂CCl₂ MXene and graphite rod were placed as the cathode and anode, respectively. Tetrabutylammonium chloride solution in acetonitrile (30 ml; 5 mg·mL⁻¹) served as the electrolyte. The applied voltage was set to different values from −2 to −10 V. The intercalation process was allowed to proceed for 10 min.

A three-electrode electrochemical cell was used to conduct the intercalation reaction. A copper foil pasted with Ti₂CCl₂ MXene and a graphite rod were placed as the anode and cathode, respectively. Non-aqueous Ag/Ag⁺ electrode (AgNO₃ in acetonitrile) was used as reference. Tetrabutylammonium chloride (TBAC) in acetonitrile (40 ml; 5 mg·ml⁻¹) served as the electrolyte. The intercalation reaction was performed at a potential of −5 V vs. Ag/Ag⁺ for 10 min. The product powders were recovered by dissolving PVDF binder in DMF.

Reaction of Nb₂CCl_{0.8}(Octyl)_{0.2} with 2-Ethynylthiophene

The substitution reaction was performed in a N₂-filled glovebox. To mimic the catalytical conditions, 5 mg Nb₂CClₓOct_{0.2} MXene and 80 mg (20 eq vs. Nb) were added to 1 mL toluene. The mixture was allowed to be stirred at 80° C. for 16 hours. Then the precipitate was carefully washed with fresh DMF for 3 times and fresh toluene for 6 times before characterization.

### Characterization Methods

The structure and composition of MXenes were characterized using X-ray characterization, Raman spectroscopy, electron microscopy and a combination of EDX and EELS analyses.

### XRD

The diffraction patterns in Bragg-Brentano geometry were obtained using a Rigaku benchtop X-ray diffractometer equipped with HyPix-400 MF 2D HPAD and a Cu Kα X-ray source (1.5406 Å) operating at 40 kV and 15 mA.

### SEM-EDX

SEM imaging and EDX elemental mapping were performed in a Carl Zeiss Merlin Field-Emission Scanning Electron Microscope equipped with Oxford Ultim Max 100 SDD. The accelerating voltage was set to 10 kV and beam current was set to 1 nA.

### STEM

Atomic-resolution characterization of the MXene samples was conducted using the aberration-corrected scanning transmission electron microscope JEOL ARM200CF at the University of Illinois Chicago, equipped with a cold field emission gun operated at 200 kV, a Gatan Continuum electron energy-loss spectrometer, and an Oxford XMAX100TLE X-ray detector, providing a sub-A probe-size and 350 meV energy resolution. The emission current was reduced to 12 Å to reduce damage from the electron beam. An electron probe convergence semi-angle of 24 mrad was used and the inner detector angle for HAADF imaging was chosen to be 75 mrad, while an inner angle for LAADF imaging was chosen at 30 mrad. The MXene samples were initially prepared for STEM analysis by drop casting particles suspended in methanol onto a 3 nm holey-carbon-covered TEM grid, which was allowed to dry over 2 hours in a N₂ glovebox maintained at <0.1 ppm H₂O and O₂. The TEM grids were then loaded onto a plasma cleaned Fischione vacuum transfer holder and inserted into the microscope column without atmospheric exposure.

### X-Ray Fluorescence (XRF)

XRF analysis was performed with a benchtop Energy Dispersive Rigaku NEX DE VS X-ray fluorimeter equipped with a Peltier cooled FAST SDD Silicon Drift Detector. All analyses were carried out under He atmosphere to increase sensitivity for lighter elements. Elemental ratios were determined using the standardless thin-film fundamental parameters method as programmed in QuantEZ software provided by Rigaku, using the standard Rigaku calibration protocols. The samples were prepared by drop casting powders dispersed in anhydrous methanol on a Si substrate of an approximate 1×1 cm² size. The analysis window during measurement was set to a diameter of 10 mm.

### X-Ray Photoelectron Spectroscopy (XPS)

XPS analysis was performed on a Kratos Axis Nova spectrometer using a monochromatic Al Ka source (1486.6 eV). Ti 2p, C 1s, and N 1s high-resolution spectra were collected using an analysis area of 0.3×0.7 mm² and a 20 eV pass energy with a step size of 100 meV. Peak fitting of high-resolution XPS spectra was performed with CasaXPS software. A Tougaard background was used for better quantification of transition metal-based compounds. (M. Repoux, Surface and Interface Analysis 18, 567-570 (1992).) The Ti 2p region consists of the two 2p_{3/2} and 2p_{1/2} components arising from spin-orbit splitting; the peak area ratio of 2p_{3/2} to 2p_{1/2} was fixed to 2:1. The Ti 2p region was fit using three pairs of 2p_{3/2} and²p_{1/2} components for each sample: two for the MXene components and one for TiO₂. The two pairs of MXene component peaks were fit using the asymmetric Lorentzian line shape. (M. C. Biesinger et al., Applied Surface Science 257, 887-898 (2010).) The TiO₂ peaks were fit using a symmetric Lorentzian-Gaussian line shape. The C is and N is regions were fit using symmetric Lorentzian-Gaussian line shapes. Since the Fermi edges were not sharp enough to use for calibration, the binding energy of the C is peak for Ti—C—Ti was fixed at 282.0 eV to compensate for any shifts caused by sample charging as Barsoum et al. suggested for carbide MXenes. (V. Natu et al., Matter 4, 1224-1251 (2021).) For other MXenes, calibration was performed by setting the C is adventitious carbon peak to 284.8 eV.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A method for the synthesis of a two-dimensional transition metal carbide MXene having a formula Mₙ₊₁CₙTₓ, where 1≤n≤4, M is an early transition metal, and Tₓ are surface terminating halogen atoms, the method comprising: reacting the early transition metal with one or more alkyl halide compounds at a temperature at which the reaction forms the two-dimensional transition metal carbide MXene.

2. The method of claim 1, wherein the one or more alkyl halide compounds comprise dichloromethane.

3. The method of claim 1, wherein the one or more alkyl halide compounds comprise dibromomethane.

4. The method of claim 1, wherein the one or more alkyl halide compounds comprise diiodomethane.

5. The method of claim 1, wherein the one or more alkyl halide compounds comprise a mixture of dichloromethane and dibromomethane.

6. The method of claim 1, wherein M is Ti, Zr, or Nb and T is Cl, Br, or a combination thereof.

7. The method of claim 6, wherein M is Ti and T is Br.

8. The method of claim 1, wherein the two-dimensional transition metal carbide MXene is a mixed metal two-dimensional transition metal carbide MXene comprising at least two different early transition metal elements.

9. The method of claim 1, wherein reacting the early transition metal with the one or more alkyl halide compounds comprises reacting the early transition metal with at least two different alkyl halide compounds, wherein the two different alkyl halide compounds comprise different halogen atoms, and the two-dimensional transition metal carbide MXene has a formula Mₙ₊₁Cₙ (T′T″_{1-y})ₓ, where T′ and T″ represent the two different halogen atoms, and 0<y<1.

10. The method of claim 1, wherein the synthesis of the two-dimensional transition metal carbide MXene is carried out using chemical vapor deposition growth on a surface of a substrate comprising the early transition metal by:
exposing the surface to a vapor comprising the one or more alkyl halide compounds; and
reacting the early transition metal surface with the one or more alkyl halide compounds at the temperature at which the reaction forms the two-dimensional transition metal carbide MXene.

11. A two-dimensional transition metal carbide MXene having a formula Mₙ₊₁Cₙ (T′T″_{1-y})ₓ, where 1≤n≤4, M is one or more early transition metal elements, T′ and T″ represent two different halogen atoms, and 0<y<1.

12. The two-dimensional transition metal carbide of claim 11, having a formula Ti₂C(Cl_{y}Br_{1-y})₂, where 0<y<1.

13. The two-dimensional transition metal carbide of claim 11, having a formula Nb₂C(Cl_{y}Br_{1-y})₂.

14. A method of alkylating a two-dimensional transition metal MXene having a formula Mₙ₊₁XₙTₓ, where 1≤n≤4, M is one or more early transition metal elements, X is carbon or nitrogen, and Tₓ are surface terminating halogen atoms, the two-dimensional transition metal MXene comprising a stack of monolayer MXene sheets, the method comprising:
electrochemically reducing the two-dimensional transition metal MXene having the formula Mₙ₊₁XₙTₓ in an electrolyte solution comprising an alkyl group-functionalized quaternary organic cation in a polar aprotic solvent, wherein the electrochemical reduction drives intercalation of the alkyl group-functionalized quaternary organic cation between the monolayer MXene sheets and the formation of an ionic quaternary organic cation-MXene compound; and
replacing the polar aprotic solvent with a non-polar solvent to induce a carbocation transfer between alkyl groups on the alkyl group-functionalized organic cation and early transition metal atoms of the two-dimensional transition metal MXene to form the alkylated two-dimensional transition metal MXene.

15. The method of claim 14, wherein the alkyl group-functionalized quaternary organic cation is a quaternary ammonium cation.

16. The method of claim 14, wherein the alkyl group-functionalized quaternary organic cation is a quaternary phosphonium cation.

17. An alkylated two-dimensional transition metal MXene having a formula Mₙ₊₁XₙTₓ, where 1≤n≤4, M is one or more early transition metal elements, X is carbon or nitrogen, and Tₓ are surface terminating atoms or groups, wherein at least some of the surface terminating atoms or groups are alkyl groups covalently bonded in M atoms of the MXene via C-M bonds.

18. The alkylated two-dimensional transition metal MXene of claim 17, wherein the surface terminating atoms or groups comprise the alkyl groups and halogen atoms.

19. The alkylated two-dimensional transition metal MXene of claim 17, wherein the alkyl groups comprise C₂ to C₁₂ alkyl groups.

20. The alkylated two-dimensional transition metal MXene of claim 17, wherein M is Ti, Zr, or Nb.
